(19) United States
(12) Patent Application Publication
(10) Pub. No.: US 2013/0305169 A1
(43) Pub. Date: Nov. 14, 2013

(54) Methods and Systems for Providing Feedback in Interactive, Interest Centric Communications Environment

(71) Applicant: Robert Evan Gold, Dallas, TX (US)

(72) Inventor: Robert Evan Gold, Dallas, TX (US)

(21) Appl. No.: 13/890,203

(22) Filed: May 8, 2013

Related U.S. Application Data
(60) Provisional application No. 61/645,938, filed on May 11, 2012.

(51) Int. Cl. G06F 3/0481

(52) U.S. Cl. CPC G06F 3/04815
USPC 715/757

(57) ABSTRACT

A method for providing feedback in an interest centric, interactive communications environment includes providing one or more electronic devices configured to communicate over a communications network. The method includes providing one or more servers configured to provide interactive data to the electronic devices over the communications network and to control the interactive data and to coordinate participant activities via the electronic devices over the communications network. The method includes monitoring a condition of at least one of the participants via a capture device on the electronic device and generating a condition signal responsive to the monitored condition and transmitting the condition signal to one of the servers. The method includes analyzing by the server the condition signal to determine an emotional state of the participant and providing feedback to the participant based upon the determined emotional state.

### CROSS REFERENCE TO RELATED APPLICATION

This application claims the benefit of U.S. provisional application no. 61/645,938, filed May 11, 2012, entitled “VIRTUAL ENTITY AND INTEREST CENTRIC COMMUNICATION, INTERACTIVITY, AND ACCOUNTING SYSTEM AND METHOD”, which is incorporated in its entirety by reference for all purposes.

### FIELD OF THE INVENTION

The present invention relates generally to a system and method for a communications operating system. Specifically, the present invention relates to a communications operating system that provides an interest centric virtual environment for a person who participates in the communications operating system (a “participant”) giving access to communicate with other participants enabled by the communications operating system, and allows real-time updates and changes to the currently active interest. The present invention further provides a communications operating system that may learn, over time, a current participant's interests, and provide updates to the current participant's current emotional state through feedback. The present invention may also provide a communications operating system that provides a structure for the field of accounting, such as management, project, and resource accounting expands beyond current measures insomuch that: measures for accumulation, consumption and utility; becomes a tiny subset extending accounting into an interactive awareness providing certainty beyond the past, into the present and future insomuch that: linearity and processes for the most part disappear.

The present invention may be discussed in terms of usage, features and database like structures even though it may be embodied as an operating system that functions on all equipment and replaces (modifies) or overlays all other operating systems it is designed for, such as mobile phones, Windows or iPhone, tablets, netbooks, computers, televisions, kiosks or other devices functioning by the likes of Google Chrome OS or Apple OS or Windows OS or Linux OS and so on. The operating system may allow the participant to still retain access to these other operating systems, servers, cloud related technologies and so on as the basis of its functionality is connectivity with web and server environments regardless of the differing operating systems. The operating system may include other aspects of Google Chrome OS, iOS, Mac OS x, Unix related operating systems, Windows Operating Systems, Lisp based systems and other proprietary Unix and non-Unix systems, network systems, web operating systems.

### BACKGROUND OF THE INVENTION

Technology has become a prevalent part of modern communication mediums. In particular, people have become reliant upon electronic devices such as desktop computers, notebooks, portable tablets, mobile phone, portable gaming devices, televisions and other various electronic devices to name a few, with the devices typically providing some form of networking capabilities for communicating among different devices. In particular, these electronic devices typically provide network access to the internet, and may host numerous network applications (such as browsers, search applications, social networks, audio/visual applications), games, radio, television, maps and many other items too numerous to mention. This electronic technology has gained in popularity and has impacted organizational, educational and societal cultures. The advantages of this electronic network connectivity has allowed for rapid advances in communications mediums as well as an increase in the popularity of such electronic devices. However, these advantages have also increased the controversy surrounding the use of such devices. The popularity might be in part with the rapid availability of “information” and social connectivity, while the controversy seems to appear in frequent interruptions, distractions and complaints of withdrawal from personal relationships of those in physical proximity.

It has been noted in several sources that there appears to be a growing disconnect or a marked difference between the activities and ways of relating when people engage in ‘gaming,’ ‘social media’ and other virtual environments as opposed to real-world environments. These differences are becoming considered as potentially divisive as different personalities are said to be manifested. For instance, it has been noted that the social etiquette of social networks differs from social networks in the physical world, often for the worse.

Part of this increasing disconnect between online, and virtual activities as opposed to real-world interactions stems from the way applications, browsers, email and other communications platforms in personal life as well as business organizations are implemented. Typically, these virtual interactions are performed on specific devices, and may have certain limitations as to what interactions may be performed on which device. Organizing interactions, commitments, meetings, events, projects, resources, interactions, information, accounting, and other transactions requires time, skill and effort. Awareness of how delays, interruptions, availability and coordination of resources, engagements, accounting and other factors are often problematic. For example, locating important documents, correspondence, web sites, resources and other organization oriented tasks are many times time consuming and frustrating. This is further complicated by the often common situation where a person has multiple phone numbers (home, work, mobile), numerous email accounts, different addresses, different phone directories, as well as various conversations and correspondence possibly spanning several different applications and devices.

Typically, the way a person organizes conversations, applications, emails, documents and other communications are by way of folders, trash, spam filters, answer machines, and voice mail. While there may be several different ways of sorting these linear events, over a given period of time the number of documents, communications, appointments, commitments with other parties inevitably become massive. Further, new and different modes of communication continue become available other than talking on the phone or receiving email. There are also chatting, video conferencing, collaborative areas like Google docs and more sophisticated software to coordinate activities, planning or designing.

Besides the obvious disconnect of all these different systems and methods, there are processes that require post activities, such as many types of process software, calendars to schedule future events, accounting and operations interfaces that require data entry and so on. There are also periods of negotiation and then periods of time devoted to producing documents and agreements, many times requiring several passes before the final document represents the agreements. Then, in time, there are changes related to translating the agreements into operations and scheduling and so on. Issues of accounting of finances and resources are disjointed as issuances and changes might occur verbally, in person, on the phone or written, through email, texting and other means requiring updating systems managing finances and resources. Furthermore, the different means for accounting might span many different systems, such as online payment systems, on-line banking, customer, supply and employee relations management systems, information systems, project management, service and sales order systems, collaborative systems, and advanced systems from Oracle, SAP as several examples. The complexities of these activities have produced many applications and systems to assist in coordinating these activities, most requiring a separate interface.

Several systems are also designed to mine all this data, providing some kind of display or dashboard for management so as to better anticipate the future. However given the many systems requiring input and entries, the lack of follow-through for plans, agreements and commitments, users of such systems may consider the forecasted future events as being too optimistic and untrustworthy. Furthermore, these varying expenditures for systems are very costly for personnel to update: data is compiled and taken as some semblance of the future, trustworthy or not. The data is generally made available to a select few in organizations and may offer little real-time benefits for personnel engaging in the interactions. In regards to scheduling finances and resources, many times these accountabilities are isolated in specific systems, and difficulty may occur when plans change in one system and not the other, which adds to the unreliability and lack of coherency between systems. The resources affected are sometimes excluded as at in any specific moment in time, the elements collected are incomplete.

Thus, in many instances, current software used to keep users organized fail to accomplish this objective. This is because current software still requires significant amounts of user assisted input. For instance, what is not recorded or otherwise input into a traditional software program is unavailable to the user. Regardless of whether individuals are tied into larger systems, there are times when plans, commitments, agreements and/or appointments that a user forgets to set are many times forgotten. In other instances, when specific commitments or meetings are not fully determined, the commitment or meeting simply fails to materialize. Pertaining to agreements and commitments, communications between persons can be ineffective at many times. What is said by one person may not be what is heard or remembered by the intended audience, and is generally not recorded in any way. Specifically, sometimes people and their communication are tuned out. At times, the reason for this communications attenuation is due to the emotional state of the persons involved in a communications. For instance, when a person becomes too cerebral or too aggressively involved with a specific topic, view, expression, and/or experience to reliably connect with others. In those situations, the person typically begins to tune others out, and may only comprehend the communications that they want to hear. These characteristics of communication create many problems, which often relate to the well-being of relationships and economies.

These communications problems are further compounded by the multitude of available communications programs and mediums currently available. The existing applications, especially social networks appear to be linear in design. Facebook currently has a linear structure wherein the most current string of linear blurbs are elevated to the top. The defunct Google Wave also had linear blurbs although the idea of rewinding “waves” paralleled a similar feature of documents in MS Word was an interesting twist that provided a valuable utility as well as a design fashioned by way of Apple iPhone and other products. The simultaneous capacity to alter a document gave it an added advantage over texting or instant messaging. Google+ is another social network, once again linear. There are also collaborative products including Google Docs that promote collaboration for the masses. Some of these methods occur in application within operating systems and others are made available via a web browser. Current communications technology also includes audio video applications. Skype is one well known application; another is “hangout” on Google+ or the video capabilities via Google TV as another example. There also are electronic whiteboards that exist that allow for people to simultaneously work together like Twiddla as an example.

Furthermore, with regard to currently available electronic devices and applications, there are different devices suitable for use depending on the physical location and activity of a particular person. For instance, a person at home may utilize a desktop computer to access the internet and chat with other users, whereas the same person may prefer use of a mobile tablet computing device while watching television in the living room. Another desktop computer may be similarly available to the person in the work environment. For individuals that require more mobility, notebook/laptop computers provide a mobile computing platform for interactivity. Even more inherently mobile electronic devices may be available to the person during travel, such as an onboard computer located inside an automobile, or a tablet computer for travel on public transportation. Another inherently convenient and powerful electronic device is the mobile phone. Each of these different electronic devices represents a different aide and instrument (tools and applications) for a different yet important aspect of life. Furthermore, there are different people and resources that are important in these different areas of life. The people, resources, applications and access to specific events (information) may be either device, application, or location dependent.

It would be desirable for these devices to be able to provide for an initial identifying or authentication method for the communications system, and allow a participant to either manually or automatically authenticate and identify with the communications system for security purposes as well as in order for the communications system to load preferred configurations tailored to the participant. It would also be desirable that the communication system provide a consistent and coherent environment that was independent of different (separate) systems, applications, sites, schedules, and methods of communication, like telephones, emails, conferencing and texting.

It would be further desirable for these devices to be predominantly non-discriminatory. In other words, regardless of the physical location of the person, so long as there is access to a communications capable electronic device, the devices may be designed to work in unison to give the person a seamless way of relating with a virtual world that mirrors what is important to each individual at any particular moment. Each of these devices may be viewed as a window to the virtual world, with each window providing at least a basic, standard view level, that these devices are ubiquitous in nature. It would also be desirable for all communications regardless of their origin to occur in the organization of this virtual world.

It would also be desirable for such a communications system to allow participants to coordinate and collaborate with each other through interactions. Such interactions may be audio, visual, haptic, or combinations thereof. Interactions have, in the last few years, been recognized as the vehicle for progress. With the tremendous speed provided by modern advances in technology, the time between interactions and transactions has been greatly reduced or diminished in many cases. However, regardless of the almost simultaneous occurrences of interactions, no transaction occurs without some manual interaction or specific intent or act on the part of a participant. Thus, it would be desirable for a system wherein all interactions or transactions may occur in a seamless manner. Further, it would be desirable where all interactions or transactions including those pertaining to finances, resources and so forth, are accounted for within this environment distinguished by interest or area of importance. Further that these interests whether accounted for as an individual, a family, and/or organization, that this accounting would be relevant temporally (In time, affecting the past, present and future). That this accounting would reflect that these interactions occur in time. Further that as the conditions relate to specific times temporally that at that point in time, the interactions are made available when selected and/or relevant. That these interactions and the agreements and commitments (as they affect finances, resources, interests and so forth) are accounted for in a temporal environment and maintained structurally (a scheduled or calendar type format for ease of assess) at moments that would not be relevant or timely.

Therefore, a need exists for a communication system that resolves these problems and provides a virtual assistant that unifies the functionality available among various electronic devices in an ubiquitious manner, that a participant may interact with and is able to provide a participant profile that accurately captures the participant's interests, resources, support, temporal undertakings, current and future patterns, habits, and preferences. There is further a need for a communication system that is able to react to new situational developments, delays and changes as well as to changes with the current interest (such as a change in relationship with a resource or finance) of the participant without posterior actions, entries, or other processes outside of the current interaction. There is additionally a need for a communication system that provides further support and customization for specific types of interests depending on whether the participant is interacting as an individual, or as a family member, or in relation to an organization.

### SUMMARY OF THE INVENTION

The present invention may be implemented as an application that takes over the operation of the screen and/or user interface of an electronic device, and may also be implemented as a communications operating system (“OS”) of the electronic device. The communications OS may be applicable to all manners of electronic devices, including but not limited to: computers, televisions, mobile phone, mobile tablets and other similar electronic devices. Typically, electronic devices for running the communications OS may support the following hardware features: static screens, graphics tablet-screen hybrids, touchscreens, keyboards (physical and virtual), keypads, mice, trackballs, stylus, or other pointing device, network connection (wired or wireless), microphones, speakers, cameras, and other sensors or interfaces for input/output devices. The electronic devices may also contain processors, memory, storage devices, and media readers for processing information gathered and shared between the various hardware features. The communications OS of the present invention may also be implemented so as to coexist with the current operating system or user interface of an electronics device. Thus, though the use of the communications OS, common communications functions such as email, browsers, searches, phone numbers, and so on will no longer be a tool or something separate from a participant's activities. Rather, a paralleled virtual environment exists for each participant or entity, and the communications OS may provide for each moment to moment experience and interaction within a structure which may replace what previously occurred as a process-oriented, linear environment.

The Communications OS may provide an environment that is relative to each participant or entity. In order for the communications OS to provide a unique environment for each participant, the communications OS additionally allows for a participant to authenticate or identify with the communications OS prior to beginning interactions within the virtual environment. These authentication features include, but are not limited to the following: passwords, fingerprint or handprint scanners, facial recognition, optical or retinal recognition, voice recognition, other biometric authentication, physicality, location, implant, other physical and electronic identifiers, as well as geolocation devices.

Within the virtual environment provided by communications OS, an organizational entity may have areas that are designed with organizational interests and concerns in mind, with interactions between the participant and communications OS being interest centric. An interest may be anything that is of concern or matters to the participant or entity (organization). That is, during interaction with the communications OS, an electronic device may automatically configure and adjust the communications environment for interactions with regard to a certain active interest of the participant or entity. As the participant or entity's current interest shifts, so does the virtual environment. Different resources may be present to the participant or entity depending on the current interest. Some of these resources may be participants that can be invited into a current ongoing activity, such as a conversation. Because communications OS may tailor the participant's environment for a network device based on the participant's current interest or concerns, the communications OS may provide a unique and distinct environment for each different participant or entity, all of which may be reflected in each participant's point of reference. Participants may engage in real-time communication via text, audio and audio/visual mediums with access to a whiteboard, graphics and any other tools available to the communications OS. Some participants may participate in asynchronous (non-real-time) communication via text, audio and audio/visual mediums with access to a whiteboard, graphics and any other tools available to the communications OS and still be engaged in interactions and interactivities.

The communications OS may connect to one or more external servers, such as a cloud network, in order to download and receive data on the participant's particular configuration for the virtual environment. The downloading data may be used to synchronize content between the external servers and the electronic device(s) being used by the participant. The communications OS may further connect to a cloud network in order to communicate with an entity provider and various service providers, which may provide a database of content relied upon by the communications OS to provide an interactive environment for participants.

Within the virtual environment set by the communications OS, each participant has a unique, relative experience of their environment. Visual, auditory, haptic or any other sensory feedback that an electronic device may support allows for feedback of the current emotional state of the participant as they interact with the communications OS. The virtual environments accessed by the participants of communications OS may be defined or configured by each participant or entity. Specific preferences of each participant's environment may be developed, designed and formulated. The virtual environments may not be limited to functioning in a manual fashion, but may be configured to function as interactions within the environment itself. That is, each participant may specify and configure exactly what the participant wants available within the virtual environment; just as each person can choose furniture for a room, each interest configured by a participant may have his or her own environment. The virtual environment and interests may thus be designed as the participant chooses, empowering each participant to provide themselves an intuitive experience of their own design. Organizations may have flexibility to create structures that support each unique organizational business practices and interests. However, the ways in which these structures occur in the participant's environment may be participant or entity centric. In addition, the participant's relationship with various organizations may provide for an organization-centric aspect to the virtual environment. This may allow for a participant to interact within the virtual environment on different entity levels, such as interaction on the individual, family, work, church, and/or group membership levels.

Within the virtual environment of the communications OS, coordination with other participants may be in real-time and/or available when some or all of the participants become available. Scheduling takes into account all of the participants' calendars and schedules, allowing the interactions to be paused and restarted at a later time, or it may allow a participant to leave for a short period of time and rejoin in the current moment of the ongoing interaction. There is a historical remembrance of the interaction; in other words, everything is captured and can be replayed. Such replay functionality may be the ability to go back to an earlier moment of an interaction by use of a calendar/scheduler of history, and may further include future plans, agreements and commitments of that interaction. In essence, every moment of time for a particular interaction is accounted for and accessible through the calendar/scheduler. Furthermore, each measure of agreements and commitments as they relate to time are accounted for and accessible through the calendar/scheduler. As agreements and commitments change, the new measures and/or temporality are accounted for and accessible through the calendar/scheduler from a more present time reference of the interaction. Measures of the agreements and commitments, terms, conditions, resources and finances may have both explicit and implied references as to provide continuity, consistency and coherency with current accounting practices and standards.

In the virtual environment of communications OS, interactions between various elements, and other participants may be available to a participant, such as text or video conversations. As the interactions develop, some ideas may be erased and replaced with what is currently relevant. The history of these changes may be available within the communications OS, however the current discourse remains simple as only the current interaction of interest to the participant remains present. In this way, everything remains simple over time instead of becoming complex, and distracting the participant. Planning for the future also allows what becomes relevant currently to show up. Interactions remain relevant to the issues posed within the interactions, and are not linear. In time, interactions that are or will become immediately pertinent to the participant's current interest will become available on the desktop of the communications OS Likewise, in time, interactions that have already occurred and are in the past, may become less visible to the participant, and may reside in a calendar which the participant may later access. In this manner, only the most pertinent interactions will most prominently appear in the interactions area of the desktop for the communications OS.

To illustrate the new and novel benefits afforded by the communications OS, a hypothetical scenario involving the use of the communications OS by a participant, such as a typical businessman, is discussed: through implementation of the communications OS, a participant may become aware by way of the communications OS to a previously setup arrangement and attend a virtual business meeting by way of video conferencing broadcast on the desktop of the communications OS. In the virtual meeting, the meeting attendees (including other participants who may or may not be using the communications OS) may elect to schedule a follow up meeting as the attendees agree on a time to continue. Each participant of the communications OS may have their own personalized calendar with which the communications OS may schedule the newly agreed meeting date and time. As the meeting concludes, the calendar for the participant's communications OS device may indicate something is coming up, and the participant may interact with the calendar in order to view a previous interaction indicating the time and location of an upcoming appointment, and after acknowledging the appointment, the person may begin heading towards an elevator to go to the garage. As the participant is waiting for the elevator, he opens up his mobile electronic device to view his last conversation, where he determines one of his business associates is currently active in the conversation window. The participant asks the associate to research an issue for him, and closes his mobile electronic device. Entering the elevator, the participant is the only one there, and he closes his mobile device. While in the elevator, he is asked by a communications OS integrated into the elevator, “Do you want to make a stop before going to your car, and do you want your car to be warmed up for you?” Thus, various communications OS located in different electronic devices situated in various locations may work cooperatively and cohesively together to identify a participant and present interactivity options to the participant depending on physical environmental factors as well as based off of the participant's most recent interactions and interests.

As the participant gets off the elevator, he looks at his mobile device and notes that his associate has agreed to research the issue, and asks the participant for clarification. As the participant steps into his car, he puts his electronic device away in preparation for driving. At this point the participant starts his car, wherein a communications OS located in the car is activated and immediately receives an update on the meeting that the participant is scheduled to attend. The communications OS in the car immediately provides him with a GPS screen as well as the current state of the interaction of the meeting he will be attending, as well as other information. Specifically, communications OS at the meeting location is already engaged in the preliminary aspects of the meeting with the attendees such as the participant.

As the participant reviews what might be taking place at the meeting, his wife appears in a new conversation window on the desktop of the communications OS located in the car and asks the participant if he wants to go out for dinner. She wants to know if he has any preferences and what time he will be home. He suggests meeting at an Italian Restaurant at 6:00 p.m. They conclude their conversation, while his wife is automatically continues engaging with the hostess setting up reservations for the couple at the restaurant. The communications OS also makes an appropriate entries in the calendar of both the participant and his wife. The participant considers some ideas preempting his meeting as he is pulling into the garage of the meeting location. The communications OS further identifies an appropriate parking place for his car, and he is notified that he is early for his meeting. As he parks, the walk path to the elevator is visible.

When the participant enters the elevator, a communications OS located in the elevator notifies him that one of the attendees is on the fifth floor and that there is a coffee shop in the lobby. Through the communications OS, the participant asks the attendee whether he would like to get a drink before heading up. While the participant connects with the coffee shop, he is simultaneously connected with the attendee who responds that he would like a cup of coffee as well. Using the communications OS, the participant places both of their orders with the coffee shop's personnel and gives payment access to the coffee shop who charges it. Subsequently, maps appear on the monitor located in the elevator, showing the participant the location of the coffee shop. The drinks are ready for pick-up when the participant arrives at the coffee shop.

Next the participant heads back to the elevator and arrives at the meeting where his fellow attendee greets him at the door. The two head to the conference room, which has an entire room full of screens and various participants that are present either physically or virtually, and all settling in to continue the interaction that has been taking place over the last few weeks.

While the participant and others are engaged in the ongoing meeting, the screens in front of them are constantly giving them feedback on their current emotional state. The participant has designed all screens he interacts with to shift blue when he is fully connected and engaged, red when he is in an overly aggressive mood and yellow when he is in a withdrawn emotional state—in his thoughts and closed off to what others are expressing. The screen gets darker if he does not like something and brighter when he does. In other words, the screen provides feedback on negative mood shifts versus positive mood shifts, as the participant's current emotional state shifts. This awareness allows the participant to constantly adjust and shift his communication as he is conversing and interacting. It is worth noting that the way in which communications OS provides feedback to the participant may be uniquely configured and tailored to each individual participant.

On his screen, the participant is aware of plans as they are being discussed, and how they might affect his company's resources, cash flow and profitability. Real-time analysis and speculative analysis is immediately available giving all parties from many different organizations a simultaneous means to speculate on a common project that best serves all organizations at the same time. This real-time analysis is possible as a result of the participants' relationships with organizational entities, and those relationships provide an awareness of the projects, resources, finances, and potential interaction scenarios as well as how those scenarios may influence finances and resources.

The projects throughout the company are structured and accounted for based on all the interactions relative to the company as an entity. Participants may have relationships with organizational entities and those relationships give an awareness of the projects, resources, finances, and speculative interactions that might influence finance and resources. The participant and others might be separately involved or getting coached or informed by different departments and accountabilities so that these meetings become extremely efficient yet focused on individual opportunities as well as mutual benefits.

As seen by this scenario involving a hypothetical participant, there is nothing separate from the interaction. The interaction is where the schedule takes place and when the schedule is selected the interaction shows up. When resources are considered or finances are dealt with, they occur within the interaction. This virtual environment parallels a participant's interactions and activities. When going to a meeting, the electronic device in the car is cognizant and aware of where the participant is going and may automatically provide relevant interactive options for the participant. The interaction wherein the participant is attending a meeting may continue in the form of a GPS providing the participant directions as well as the best route due to traffic. Such features may be provided by the communications OS through third party vendors, and may additionally provide various purchase options, such as purchase, rental, and subscription based services. Thus, the communications OS offers a high level of flexibility to be adaptable and configurable based upon each unique participant's various needs and desires, and may provide the customized configuration for the participant regardless of where the participant is currently located.

Another feature offered by the communications OS is a future-oriented interactivity accounting system that may provide analytical, speculative, management and planning capacities for organizing a participant's or entity's interests and concerns. In presently available management accounting environments, projects are managed using very powerful systems, albeit constrained to attaining milestones linearly. For instance, within existing accounting systems, when a change takes place, the date and times for different processes are pushed ahead in a linear fashion. In a structured environment made possible by the communications OS, processes no longer exist, other than moment to moment processes such as discussing, negotiating, and agreeing, etc. Thus, within the communications OS, as changes occur that may affect what happens in the future, the communications OS automatically and fluidly adjusts and makes either speculative or committed changes to a person's resources, including financial resources, and those changes are fluid and easily observable. That is, the automated and interest oriented functionality provided by the communications OS may further be applied to any realm of accounting: management, financial, strategic, personnel, project and other accounting.

Under the accounting system available within the communications OS, participants no longer have to directly deal with financial transactions such as revenue, income and expenses, nor are these transactions thought of as a fulfillment of an agreement or commitment but as the agreement and commitment themselves. While certain aspects of these agreements and commitments might be explicit, implicit relationships might also exist to maintain consistent and coherent practices and standards for accountancy. Examples of where the accounting features of the communications OS may be implemented include what previously occurred as sales contract management or purchase order systems. From a management perspective, cash flow becomes a misnomer as the changes in agreements and commitments provides a fabric of future relationships or structure of or for value, not some idea of notion of one thing after another (a process or linear string of transactions or budgeted future transactions). Cash explicitly has a measure each moment in the future, changing when new agreements and commitments are enacted and/or when terms and conditions of existing terms and conditions change. Even speculative positions of cash are available immediately when speculation is taking place. Whereas under currently available accounting systems, profits are realized after revenue and expenses are declared, within the accounting framework provided for by the communications OS, value is recognized as agreements and commitments that are considered, negotiated and even at the level of speculation, speculated. Committed resources exist as a structure (a relationship that occurs in time), not as a way of tracking “something” and agreements exist as another structure (the relationship between agreements and value are established in time as the commitment of resources are also established in time), not as something to track and manage. Resources may exist as entities, for instance: individuals, departments, groups, among others. For example, in a service company, plumbers may exist as an entity of which each individual plumber is a member of, or are related to the entity “plumbers.”

By way of example, in business, an executive may be accountable for “plumbers” and a dispatch department. And instead of managing plumbers as things as an example, under the environment provided by the communications OS, the executive may simply manage the agreements and commitments. Structures (stuff) may exist that act as GPS and commitment relationships whereas the structure gives the current future for the agreements and the resource “plumbers” as the interactions coordinate interactions with individual plumbers with the customers as the agreements are satisfied. Individual plumbers are members (related to an organizational entity) of the resource, “plumbers.” Insomuch as there are simple interactions to bring plumbers into in order to satisfy the conditions for the request for service for example, a dispatcher. From an individual plumber's perspective, in his/her interest of work, being a member of the resource, “plumber” gives a direct relationship with dispatch, which might be another entity.

Ultimately the time between a future delivery and agreed compensation occur inside the interaction which created this relationship. Linear notions like change orders or requests for proposals and the many other methodologies for interactions disappears as interactions are simply interactivities and as changes occur the structure changes. The correlation of finances and resources isn't devised as some separate process, it is simply interactively derived. The derivation is structural in nature. The structures are interactivities and occur in time. Accounting is structurally derived in terms of agreements and commitments in time. Accounting is less evident or suitable for reports and more visible in calendar type structures.

In the hypothetical case of buying coffee, the participant not only had the transaction occur as a credit to the credit card account, but the agreement of the credit card company and the commitment of the participant to pay a certain owed amount at a later date also changed. The participant was not only aware of the credit card transaction, but also the recurring interaction with the credit card company and the influence on the participant's cash position when the cash transfer with the credit card company is scheduled to occur. From an income perspective, this participant was also aware of the agreement with their employer and the commitment of that employer to the participant. If the participant quits or gets fired, then the agreements and commitment changes based on the negotiated separation as an example of structural changes and how much more present the current future occurs. That is to say if an employment or contractual work arrangement is severed, the financial future for the participant changes structurally by whatever agreements and commitments occur in the interaction that modify the relationship with the entities involved. Financial obligations may thus be immediately settled, and research and preparation that would normally occur in a linear process oriented environment is no longer required. Once the project and financial measures are agreed upon, the participant may severe the entity from the interactions by breaking the relationship between the organizational entity if desired. The future income from the entity would no longer exist. Any final financial remuneration would be captured, and all personal finances remain as the essence of the entity via the entity server.

It is therefore a general aspect of the present invention to provide an improved communications operating system and method for a variety of electronic devices, such as computers, notebooks, tablets, and other current or potential communications capable electronic devices.

It is another aspect of the present invention to provide a communications operating system that may run on an existing operating system on an electronic device, and to provide a communications operating that may run as a stand-alone operating system.

It is yet another aspect of the present invention to provide an interest centric communications system that is driven by a participant's interests and attendant environment, and may be accessible whenever and wherever by a participant.

It is another object of the present invention to provide a participant with a continuous system for communicating and interacting with other participants or with just the participant relating to himself or herself that may learn, through feedback, a participant's interactions in order to automatically adjust conditions in response to the participant's then current interest.

It is still another object of the present invention to receive feedback from the interactions and current physical location of a participant, and to utilize the feedback to provide tailored suggestions for further relevant interacts for the participant.

It is still another aspect of the present invention to intuitively determine a participant's current interest and emotional state based upon feedback received from the participant's facial expressions and other physical indications by the participant, tonal inflections while speaking, or a participant's choice of words during a conversation.

It is another object of the present invention to automatically verify the identity of a participant in relationship to other participants before allowing the participant to interact with the communications operating system.

It is yet another object of the present invention to provide an interactive structural, analytical and speculative accounting system for automatically managing and facilitating a participant's or entity's finances and resources. The facilitating of this participant's or entity's finances and resources gives access and awareness to the current and continually altering future conditions. Thus effectively expanding accounting (current standards at the time of this filing) through interactivity coherency from a dimensionality of revenue minus expenses equaling profit and assets minus liabilities equaling equity with a coherent and consistent interactive dimension and a future orientation that can be represented by agreements minus commitments equaling value. (Whereas, agreements and commitments might be related to or referred to as future revenue and expenses, respectively.) To provide coherency with current practices (as of the date of this filing) a future orientation of equity is one way to demonstrate current a version for current standards. Interactions occurring as a coherent structure and as a foundation for a new paradigm for accounting transforms accounting, and essentially what has been related to as the differing branches of management accounting.

According to disclosed embodiments, a method for providing feedback in an interest centric, interactive communications environment includes providing one or more electronic devices configured to communicate over a communications network. The method includes providing one or more servers configured to provide interactive data to the electronic devices over the communications network and to control the interactive data and to coordinate participant activities via the electronic devices over the communications network. The method includes authenticating one or more participants by the electronic devices. The method includes monitoring a condition of at least one of the participants via a capture device on the electronic device and generating a condition signal responsive to the monitored condition and transmitting the condition signal to one of the servers. The method includes analyzing by the server the condition signal to determine an emotional state of the participant and providing feedback to the participant based upon the determined emotional state. The method includes modifying the interactive data based upon the determined emotional state, wherein the interactive data comprises at least one of interest items, relationship and resource items and stuff.

According to disclosed embodiments, the monitored condition includes a facial expression of the participant. According to disclosed embodiments, the monitored condition includes at least one of the following: vocal inflections, skin color, body temperature, retinal condition, infra-red signatures, electromagnetic signals and electrostatic signals. According to disclosed embodiments, the monitored condition includes word selection utilized by the participant during interaction with the communications environment.

According to disclosed embodiments, the capture device is camera. According to disclosed embodiments, the capture device is selected from the group consisting of: microphone, infrared sensors, optical sensors, electromagnetic sensors, temperature sensors and electrostatic sensors. According to disclosed embodiments, the feedback comprises visible feedback. According to disclosed embodiments, the feedback comprises audio feedback. According to disclosed embodiments, the feedback comprises haptic feedback. According to disclosed embodiments, the visible feedback comprises adjusting the appearance of a desktop of the electronic device. According to disclosed embodiments, the appearance of the desktop is adjusted by displaying different colored hues correlating to different emotional states of the participant. According to disclosed embodiments, the visible feedback comprises different brightness levels correlating to different emotional states of the participant.

According to disclosed embodiments, a data processing system for providing feedback in an interest centric, interactive communications environment includes at least one processor and a memory connected to the processor. The data processing system is configured to: authenticate one or more participants of electronic devices; monitor a condition of at least one of the participants via a capture device on the electronic device; generate a condition signal responsive to the monitored condition by the capture device; analyze the condition signal to determine an emotional state of the participant; provide feedback to the participant based upon the determined emotional state; and modify the interactive data based upon the determined emotional state, wherein the interactive data comprises at least one of interest items, relationship and resource items and stuff.

According to disclosed embodiments, the monitored condition comprises a facial expression of the participant. The monitored condition includes at least one of the following: vocal inflections, skin color, body temperature, retinal condition, infra-red signatures, electromagnetic signals and electrostatic signals. The monitored condition includes word selection utilized by the participant during interaction with the communications environment.

According to disclosed embodiments, the feedback comprises visible feedback, audio feedback, and/or haptic feedback. The visible feedback comprises adjusting the appearance of a desktop of the electronic device. According to disclosed embodiments, the appearance of the desktop is adjusted by displaying different colored hues correlating to different emotional states of the participant. According to disclosed embodiments, the visible feedback comprises different brightness.

According to disclosed embodiments, a system for providing feedback in an interest centric, interactive communications environment includes: one or more electronic devices configured to communicate over a communications network; one or more servers configured to provide interactive data to the electronic devices over the communications network and to control the interactive data and to coordinate participant activities via the electronic devices over the communications network; one or more authenticating devices on the electronic devices configured to authenticate participants of the electronic devices; one or more monitoring devices on the electronic devices configured to monitor a condition of the participants and operable to generate a condition signal responsive to the monitored condition and to transmit the condition signal to one of the servers, wherein the condition signal is analyzed to determine an emotional state of the participant and to provide feedback to the participant based upon the determined emotional state, and wherein the interactive data is modified based upon the determined emotional state, and wherein the interactive data comprises at least one of interest items, relationship and resource items and stuff. The electronic devices comprise: one or more processors; one or more storage devices connected to the processor; and one or more displays connected to the processor. According to disclosed embodiments, the communications network comprises the Internet, a wireless network, a telephone network, a cable network, a satellite network and/or a microwave network.

As referred to hereinabove and throughout, the “present invention” refers to one or more exemplary embodiments of the present invention, which may or may not be claimed, and such references are not intended to limit nor be imported into the language of the claims, or to be used to construe the claims in a limiting manner.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged or simply as an illustration to facilitate an understanding of the invention.

FIG. 1 is a block diagram depicting the functional layout of the system components of the present invention.

FIG. 2 is another block diagram depicting the function layout of the system components of the present invention and how they interrelate to one another.

FIG. 3 is a diagram of a sample layout of a desktop of the present invention.

FIG. 4 is a diagram of an exemplary embodiment of a desktop of the present invention.

FIG. 5 is a diagram of another embodiment of a desktop the present invention.

FIG. 6 is a diagram of yet another embodiment of a desktop the present invention.

FIG. 7 is a block diagram depicting the organizational layout and connectivity of various entities and participants of the present invention.

FIG. 8 is a diagram of still another embodiment of a desktop the present invention.

FIG. 9 is a diagram of another embodiment of a desktop of the present invention.

FIG. 10 is a diagram of still another embodiment of a desktop of the present invention.

FIG. 11 is a sample of a control panel in the communications OS of the present invention.

FIG. 12 is a sample of a settings panel in the communications OS of the present invention.

FIG. 13 is an embodiment of the facial and emotional recognition capability provided by the present invention.

FIG. 14 is a diagram of still another embodiment of a desktop of the present invention with typical basic accounting T accounts illustrated.

FIG. 15 is a diagram of still another embodiment of a desktop of the present invention with another typical basic accounting T accounts illustrated.

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. As used herein, “substantially” is to be construed as a term of approximation.

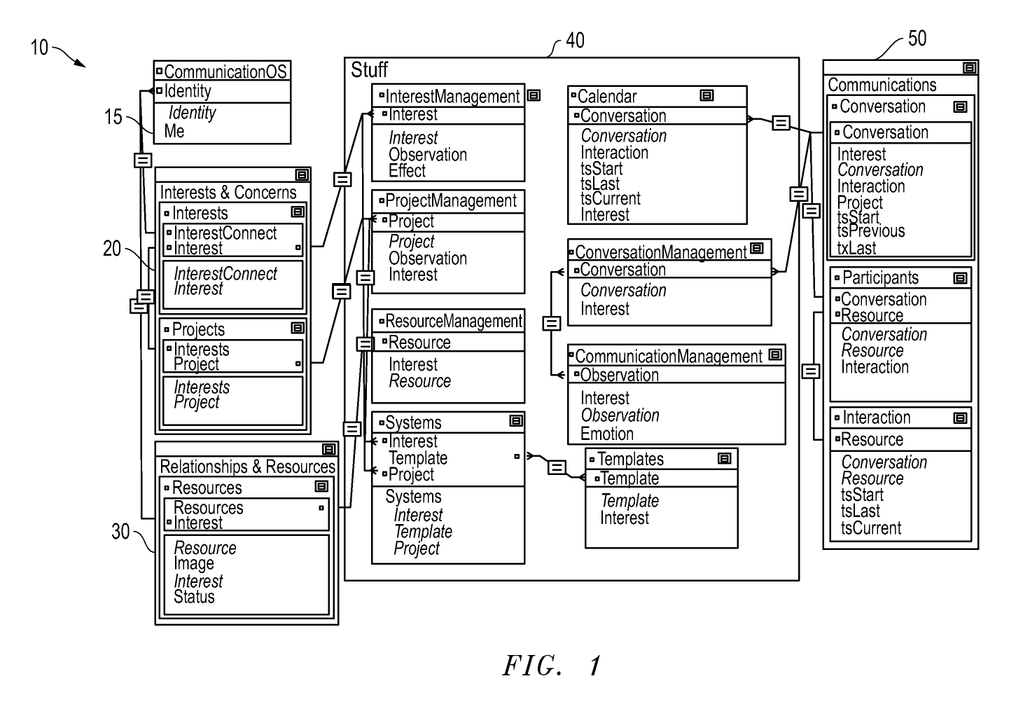

Referring to FIG. 1, there is shown a block diagram of the principal aspects and elements of the communications operating system (“OS”) 10 of the present invention, and how they are generally interrelated. The communications OS 10 may be embodied as an operating system that may be tailored for use by an individual participant or for a participant associated with one or more organizations, such as a sole propriety, a family, non-profit, for profit, etc. The communications OS 10 may further be embodied as comprising a number of elements, each of which contribute to the overall communication and interactive environment for the participant. At the basic level, the environment comprises at least the following discrete elements: identity 15; interests and concerns 20; relationships and resources 30; stuff 40; and interactions and activities 50. These discrete elements may interact with each other and allow for interaction with the current participant of communications OS 10 in order to form the overall communications OS 10. Hardware that supports the use of communications OS 10 may include the electronic devices that participants may directly interface with, along with the input and output functionality available on those devices. Hardware for the communications OS 10 may further include entity and occurrence servers as well as database servers that may connect to the electronic devices over a network. Each of these discrete elements will be further discussed in detail below.

Identity 15 may simply be the participant or entity. Identity 15 may likewise be thought of as the virtual alter-ego of the participant or entity. Although not illustrated, Identity 15 can also act for organizational constituents and entities. Identity 15 represents the center of the virtual environment of the communications OS 10, it is the subject of intelligence and influences not only the makeup of the virtual environment, but also influences the specific controls available for the electronic device displaying the virtual environment. Interests and concerns 20 may comprise different interests, each of which may be subdivided by the different issues or interest and concerns for individual participants and entities (an entity may be an organization such as a sole proprietorship, a family, non-profit, for profit, government, agency and groupings, divisions, departments and other categories). Interests and concerns 20 may further be distinguished by projects, events, designs or structures, and other developments if desired. Within the scope of the communications OS 10, there may be several various structural embodiments of interests and concerns 20. For instance, one such embodiment is oriented towards the participant's relationship with the surrounding environment. Another embodiment may be oriented toward the participant's interactions in organizational, communal or societal aspects of life. One aspect is the interests and concerns of each individual, relative to the participant and the participant's experiences of life. Another aspect is the interest and concerns of organizations or any identity that includes more than one individual. Some examples of this other aspect may be basic organizations such as families, neighborhoods, businesses, and governments. Individuals, groupings and organizations may occur within the scope of the present invention as identities. The library of resources for the interest and concerns of these communal entities may be through accessing other individuals and organizations. For instance, a “work” interest might house a structure of interests and concerns for a business. A “family” interest might house the interests and concerns for the household.

Relationships and resources 30 may comprise people and resources known to each participant. Outside relationships and resources may be allowed to request consideration by the current participant for acceptance into the closed network if desired. (Advertising as it occurs as of this filing might cease to occur generally as a broadcast. In this way, advertising occurs as specific resources consistent and coherent with real-time interests, concerns and location.) A public network may also be established. Each relationship and resources 30 may be associated with one or more interests of the current participant. If desired, networks outside the current participant's environment may be designated as a source of resources 30 as well. For example, a participant may want to have access to different social or business social networks. This invariably adds additional complexity to the virtual environment experienced by the participant within the communications OS 10, however the benefit is that the participant obtains additional latitude to their environment in a way that they choose.

Stuff 40 (Matter, material, articles, or activities of a specified or indeterminate kind that are being referred to, indicated, or implied.) may provide for the management for conversations, communications (emotional aspects), systems (connectivity and correlations with systems, services, accounting, controls, operating systems, navigation and etc.), templates (elements that can exist in conversations, be a part of conversations, provides support for conversations that may coordinate with systems, and accounting), and calendars (provides timelines for interactions and captures all time commitments, interests, projects, and resources as well as agreements, commitments and other terms and conditions). Stuff 40 may encapsulate an extensive variety of materials to support participants' interests and conversations, and may be thought of as additional widgets and applications to provide additional functionality for the participant, such as for displays, videos, operations, third party applications (robots and widgets), spreadsheets, word processors, diagrams and databases. In other words, stuff 40 may be anything that a participant has access to that he or she wishes to include in an ongoing conversation within the virtual environment of communications OS 10. By way of example only, if the current participant were utilizing communications OS 10 in a driving environment, stuff 40 may be inclusive of a GPS location indicator, a resource for directions or restaurants along the way, gas stations, or a list of persons to connect with at the destination. Stuff may also be a calendar that helps capture data sensitive aspects of the interactions, agreements, commitments, conditions, and set meeting reminders for the current participant.

By way of another example, a first participant of the communications OS 10 may be collaborating with a second participant on co-writing an article on the communication or interactivity space 50, with the first participant preferring an application from stuff 40 and the use of Microsoft Office whereas the second participant prefers using iWorks. So long as the two participants both have a template and a system translator from stuff 40, the two participants may simultaneously write the same book, either in real-time or at different time intervals. The article would occur on an occurrence service provider, wherein the participants may add their own editors, artists, and other collaborators. Each of the participants would be able to view the same article from many different points of view, depending on the template/systems chosen. It would occur as a project from different views as well. The entity provider gives each participant their specific preferred treatment and view. This is yet another example of the capability and functionality provided by stuff 40.

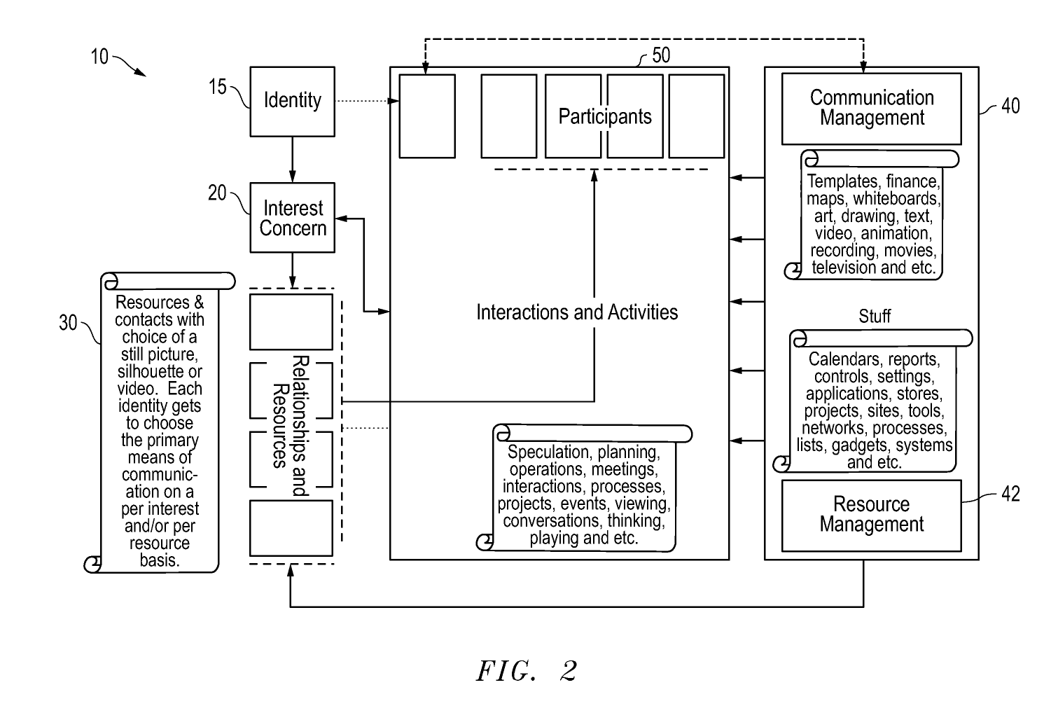

Next, at FIG. 2 is an exemplary block diagram that further explains the various elements of the present invention and how they are interrelated with one another. As discussed in FIG. 1, the communications OS 10 may comprise of the identity 15 of the participant or entity. The virtual environment provided by communications OS 10 may then be centered around the identity 15 of the current participant or entity. Thus, the communications OS 10 may seek to establish the identity 15 of the current participant or entity as a method of authenticating the participant in order to allow for other functions of the communications OS 10 to be performed.

Once the identity 15 of the current participant is established, an initial interests and concerns 20 is activated for the current participant. The interests and concerns 20 for the current participant is influenced by the current interactions and activities that are happening at each moment in time. The currently active interests and concerns 20 may alter or shift within a single interaction itself, and in doing so, the interests and concern 20 may influence relationships and resources 30, and may also influence stuff 40.

Directly affected by interests and concerns 20 may be relationships and resources 30. Only relationships and resources 30 that are consistent with the current interest and concerns 20 may be shown. The relationships and resources 30, may appear as a place holder, such as a silhouette, or a still picture, or even a video. There may also be some mechanism within communications OS 10 to help identify each contact and/or resource by name or distinction. Relationships and resources 30 may be managed by a resource management 42, which may be one of the aspects of stuff 40. Relationships and resources 30 may be available to be dragged into and utilized in conversations inside interactions and activities 50.

Next, stuff 40 may contain items that support interactions and activities 50. As shown in FIG. 2, stuff 40 may contain items such as calendars, reports, controls, settings, applications, stores, projects, sites, tools, networks, processes, lists, gadgets, and systems, among other things. Stuff 40 may also contain templates, finance, maps, whiteboards, art, drawings, text, videos, animations, recordings, movies, television shows and other interactive items. Thus, stuff 40 encompasses a multitude of items that support a wide variety of interactions. Stuff 40 may be dependent upon the current interests and concerns 20. For every different interests and concerns 20, there may be a corresponding unique combination of stuff 40.

The interactions and activities 50 may be described as a virtual parallel to real world activities. A participant of the communications OS 10 may use the interactions and activities 50 in order to facilitate interactions with others, which may or may not occur in real-time. For example, within the interactions and activities 50, a participant may participate in conversations, meetings, and other interactive activities. Further, as the participant participates in such interactions, the other elements of the present invention may shift in response, for instance the interests and concerns 20, relationships and resources 30, and stuff 40. Thus, FIG. 2 helps to illustrate the non-linear, interrelated, interest centric capability of the communications OS 10.

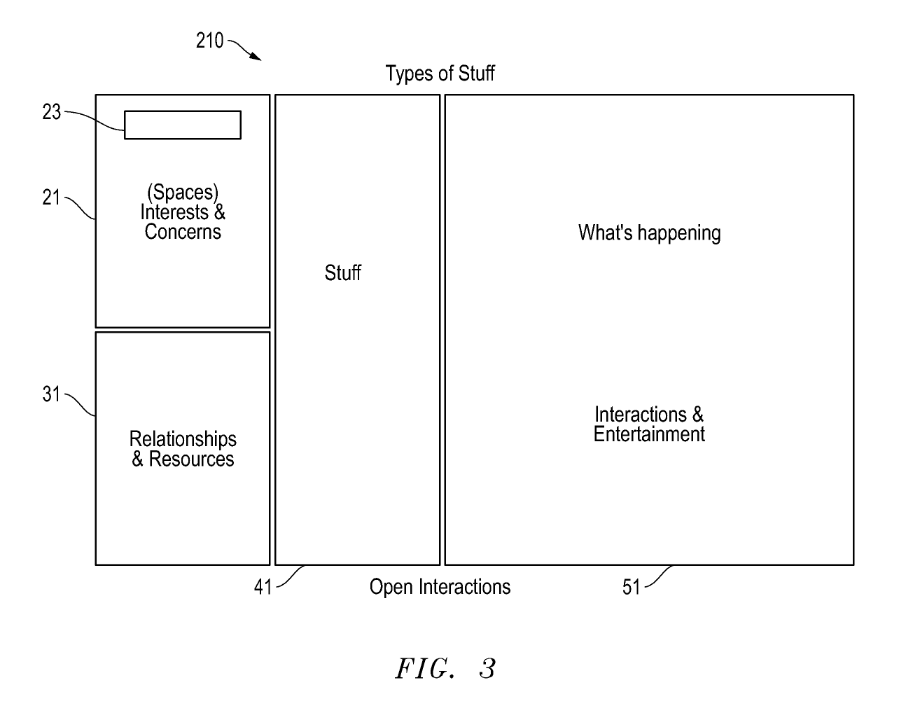

Turning to FIG. 3, there is shown a representative layout of a desktop 210 of the present invention. Desktop 210 may representatively be an interactive screen of an electronic device, such as a desktop computer, notebook, tablet, mobile device, or any other suitable, communications capable electronic device. Desktop 210 may be divided into four sections. However, depending on an individual participant's personal preferences, desktop 210 may be divided into greater or fewer number of sections. The participant may also place different sections in different areas or quadrants of the desktop 210, and may also resize the sections according to their needs or desires. In other words, the representative layout of the desktop 210 shown in FIG. 3 merely discloses a preferred embodiment of the present invention and in no way limits the various embodiments and desktop configurations possible with the present invention.

In the representative layout of desktop 210 shown in FIG. 3, an interests and concerns section 21 may be located at the top left corner. The interests and concerns section 21 may provide a list of all of a participant's interests, as well as provide an indication of the currently active interest 23. Although the participant may manually select an interest to be the currently active interest 23, the communications OS 10 may also manage the currently active interest 23 based on the context of the current participant's interactions as well as feedback from the physical world, such as determining the participant's current physical location, as well as the typical of electronic device that the participant is currently utilizing to interact with communications OS 10.

In the bottom left corner of the representative layout of desktop 210 there is shown a relationships and resources section 31, which may contain resources 30 available to the current participant. In this section, there may be list of other participants that are associated with the current participant, as well as other types of resources. The actual items located in relationships and resources section 31 may be set and configured by the participant, and may be interest centric. That is, as the currently active interest 23 is changed, whether manually by the participant, or automatically by communications OS 10, the list of items in relationships and resources section 31 accordingly changes as well. Thus, the appropriate relationships and resources 30 associated with a particular interest are automatically updated and available regardless of which interest and concerns 20 is currently active.

A stuff section 41 may be placed next to the interests and concerns section 21 and resources and relationships section 31. Stuff section 41 may include a great variety of different items or stuff 40 available to a participant, such as: (1) Calendars (Scheduling time, finances, resources and etc.); (2) Templates (Recurring formations for conditions, finances, agreements, etc.); (3) Systems (Translation for applications, systems and etc. residing on web or locally); (4) Interests or concerns—domains, projects or activities, records (history) and etc.; (5) Relationships (Words, situations and etc. are associated so that specific personal or professional relationships, resources, support and etc. appear); (6) Communication utilities (Reoccurring capture of phrases/emotional distinctions); (7) List of Interactions, projects, entertainment. Thus, stuff section 41 may contain a plethora of different types of stuff 40, each accessible to the participant during a conversation and may be incorporated into such a conversation by the participant. By way of example, one aforementioned category of stuff 40, templates, may be thought of as a type of built-in support. If the participant is currently in a car equipped with a suitable electronic device running communications OS 10, certain templates or applications such as “GPS Navigation” and “Traffic Updates” may be available to support the participant as the participant travels from one location to the next.

Another example of the concept of stuff 40 and stuff section 41 might be within an interests and concerns 20 such as entertainment. Stuff 40 may be a television list of programming, a guide for the programming, the controls for viewing programming within communications OS 10 or other nearby screens, as well as controls for pausing, rewinding and fast forwarding programming. That is, all functions related to controlling the television viewing by the participant, would be made immediately available to the participant upon selection of the entertainment interests and concerns 20, whether the interests and concerns 20 is invoked manually or automatically.

Further, the present invention contemplates the use of communications OS 10 in other novel, and ultimately useful methods. For instance, through the use of communications OS 10, an interest related to “home” may be invoked. Within this interest, lights, appliances, and other household systems may be controlled directly from the virtual environment afforded by communications OS 10. In this manner, communications OS 10 may provide the participant with energy savings as a result of such smart applications. Additional uses for communications OS 10 may be realized as the present invention gradually adopted and integrated into people's lives.

Thus, the stuff 40 available to a participant in stuff section 41 may be automatically incorporated into the participant's current activities, as determined by the current physical location of the participant along with the currently active interest 23. Stuff 40 may also be manually incorporated into the participant's current activities, as determined by the participant. And, as the participant's interactions causes the currently active interest 23 to shift from one interest to the next, the stuff 40 that is relevant to the new interest or activity will become available and moves with the participant. Further, as repetitive patterns occur within a specific given interest, the communications OS 10 may intelligently learn these patterns and relationships in order to more accurately incorporate or make available the appropriate stuff 40 to the participant for the given interest. This interactivity may be seamlessly incorporated into stuff section 41 such that the participant's activities generate fluid changes within the section.

Initially, a participant of communications OS 10 may be required to select interests and concerns 20 manually as the participant interacts within the virtual environment. Correspondingly, the participant may be required to set up and alter the initial lists of relationships and resources 30 and stuff 40 that the participant wishes to associate with a particular interests and concerns 20 as may be initially provided based on culture and preferences in profiles. Basic common concerns may be provided which are completely changeable for the participant or entity. Several examples for a participant might be: (1) family, (2) friends, (3) money, (4) work, (5) health, (6) education, and a half dozen or so more. Entities like businesses might have basic interests like: sales, operations, finances and others. In regards to resources, a few that are relied on the most might be added initially as we transition into this new environment as the participant comments, interacts and introduces specific areas of interest. However, like moving into a home, adding furniture and accoutrements, each participant may desire to develop each interest slowly. The exception to this might be an association with one or more organizations. Depending on the area of interest, (i.e., work, friends, family) different, sub-interests, project, resources and stuff may also be inherited. However, over time, as the participant continues to use the virtual environment, communications OS 10 may learn a particular participant's interests through the participant's interactions, and may begin to associate various interests with appropriate relationships and resources 30 and stuff 40. Thus, through continuous use, communications OS 10 takes the feedback received from the participant's interactions within the virtual environment provided by communications OS 10, and uses the feedback to provide a more automated, seamless experience for the participant. As an example, over time, the communications OS 10 may learn that when the current participant begins a conversation with “John G. Smith,” he is likely engaging in business discussions with a colleague at work, and may automatically adjust the interests and concerns 20, relationships and resources 30, and stuff 40 available to the current participant. Also, if the participant is engaged in a specific interaction regarding business and the area of that conversation matches an expertise, then “John G. Smith,” might prominently become available as a resource giving the participant an opportunity to add him to the interaction. Additionally, the communications OS 10 may learn that a participant's use of particular words or phrases during a conversation may mean that the participant wishes to invoke certain resources or stuff, and may then pull an appropriate calendar entry related to the conversation.

Occupying a substantial portion of the right side of the desktop 210 may be an interactions and activities section 51. Interactions and activities section 51 may provide an area for the participant to perform the previously discussed interactions and activities 50, such as carrying out an interactive conversation with other participants or may be used for multimedia purposes such as playback of music or movies. Other different types of interactions may also be possible depending upon the relationships and resources 30 and stuff 40 available to the participant. In other words, interactions and activities section 51 may be thought of as a whiteboard area for the participant to perform interactions. What influences the interactions and activities section 51, is the stuff 40 and the specifics selected from stuff section 41. The participant can alter the stuff 40, as desired, whether derived from third parties, organizations and so on. It is through the interactions that the participant performs within the interactions and activities section 51 that assists the communications OS 10 in determining what the current participant's interests 20 are, and whether the interests are shifting. Depending on the current participant's potentially shifting interests, the communications OS 10 may then determine that a new, more appropriate interests and concerns 20 may be invoked or activated in the interests and concerns section 21, along with changes to the attendant relationships and resources section 31, as well as stuff section 41.

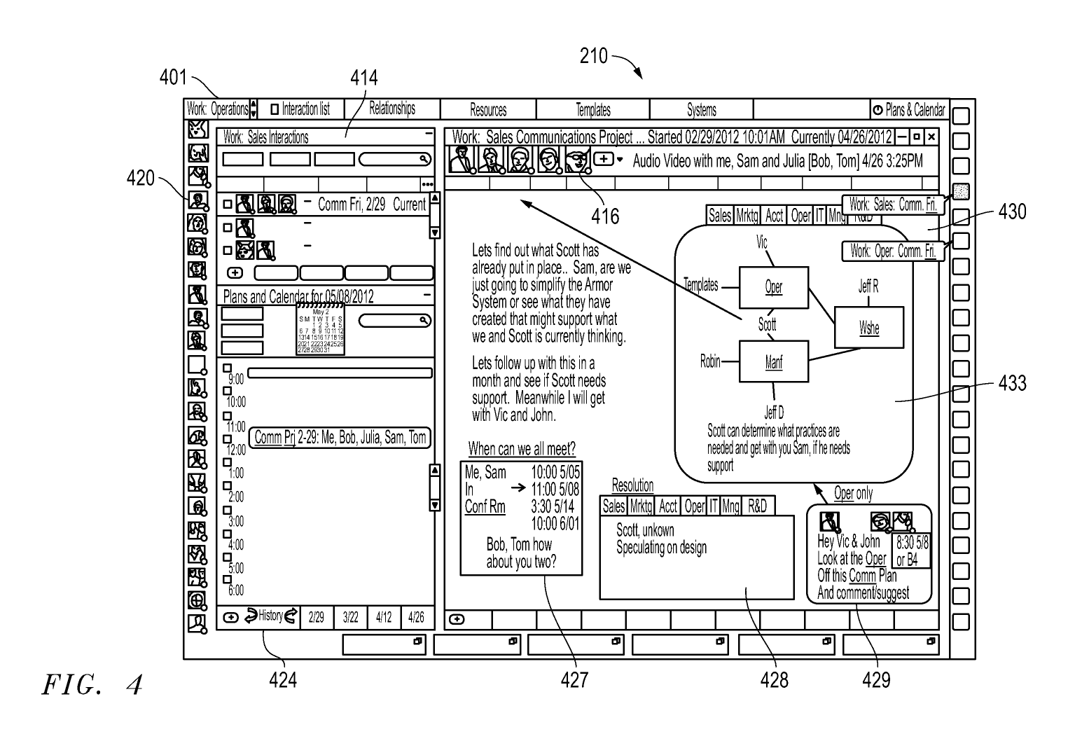

Turning now to FIG. 4, there is shown an exemplary desktop 210 of the communications OS 10, wherein the communications OS 10 is running on an electronic device, such as a handheld tablet computer. Prior to beginning interactions with the communications OS 10, the participant may be authenticated or identified by the communications OS 10. This identifying process may occur by way of one or more identifying functions available in the communications OS 10. For instance, communications OS 10 may utilize at the most basic level, a password protection system that the participant must key in, whether through a unique key combination on a provided keyboard, touchpad or other traditional input device. A password may also comprise a unique pattern that must be reproduced on a screen of the communications OS 10. The authentication or identifying function or process may also utilize other various functions for identifying the participant, such as an electronic signal from a fingerprint reader, or for publicly accessible locations, a handprint reader.

For more publicly accessible locations where it may be inconvenient for the participant to directly contact the communications OS 10, such as the hypothetical example of participant in the elevator, other participant identifying functions may be utilized, such as facial recognition, optical recognition, voice recognition, and other biometric authentication. The identifying process provided by the communications OS 10 thus provides both security for the participant's stored data within the communications OS 10, as well as allowing for each participant to be able to experience his or her own customized, unique virtual environment, regardless of the physical location of the participant and the type of electronic devices that the participant is currently utilizing to interact with communications OS 10.

Once the communications OS 10 has properly authenticated the participant, the communications OS 10 may monitor and keep track of the participant's physical location going forward. In addition to the numerous means for recognition, a GPS type methodology, such as a 911 device grid and a coordination with an entity server's awareness of the participant's location each moment may further automate the authentication capacity and further prevent fraud. In this manner, the participant remains “authenticated” within the realm of the communications OS 10 via an entity server. Should the communications OS 10 somehow lose track of the participant's physical location, a re-authentication by the participant may be required.

The current interest of the participant may be provided at 401, which may be changed by the participant by interacting with the presently displayed current interest 401. Correspondingly, a list of resources 420 (such as people associated with the particular current interest 401) may be displayed as a column on the left side of desktop 210. In this embodiment of the present invention, list of resources 420 is located on the left side of desktop 210, however in other embodiments, the list of resources 420 associated with the particular current interest 401 may be located on different parts of desktop 210, or may be hidden from view and accessed view a dropdown menu and the like. A whiteboard area 430 may be located in the right side of desktop 210 to facilitate multiple real-time conversations with other participants of the communications OS 10. Whiteboard area 430 may support multiple, concurrent, real-time conversations, with each conversation represented by a separate conversation window. Whiteboard area 430 may also support a wide variety interactions, activities, and media, including traditional textual chat, audio centric communications, as well as video chats between participants. Whiteboard area 430 also simply be used as an area wherein the participant may use as a whiteboard, for jotting down notes or may be used in any other fashion consistent with use as a virtual whiteboard.

A participant may also use whiteboard area 430 for other, non-social centric media functions. For instance, a participant may decide to read a book or other content, listen to music, watch a movie or television programming within the whiteboard area 430. The participant may also use the whiteboard area 430 to browse online content or other available network accessible content. Other electronic based interactions are also possible within whiteboard area 430. While the participant may opt to engage in these non-social functions alone, the participant may also opt to engage in these activities concurrently with other participants. Thus, a participant may watch a movie alone, or in the company of other participants, over the network interface supported by communications OS 10, and may also concurrently comment and carry on a conversation with other participants on the movie. Or, the participant may decide to access the public domain (i.e., what traditionally occurs as “browsing the internet”) to locate stores, shop for products, compare prices, again either alone or in the company of other participants who may then comment and chat about certain products with the current participant.

Whiteboard area 430 may also be used to display appropriate advertising if desired based upon the content, context, and timing of the interactions occurring within the whiteboard area 430. For instance, during a conversation or interaction among the participants, a particular product or service may be mentioned, which would cause advertising to display related to the particular product. Advertising is timely, made available at appropriate moments, specific to the current situation when a something important is recognized. Advertising may also be related to prior participant interests. Advertising might recommend stopping at the office supply store two blocks ahead as the participant is heading to the office based on a conversation that took place the previous day. The interaction might also appear on the screen 210 with the opportunity to engage in that concern for a short period of time. The participant may then be provided the option to purchase the product immediately. The advertising may be based upon the current interest and physical location of the participant, and thus, may occur as a resource 30 for the participant. Essentially, whiteboard area 430 may be an area for the participant to perform interactions within communications OS 10, and which may also be shared with other participants designated by the current participants to provide a common experience to each participant to a conversation, but concurrently providing each participant with their own interest centric perspective of the ongoing conversation.

With regard for video based media, whether the video is part of a video conversation between participants, or a movie being watched by the current participant, whiteboard area 430 may provide full-screen support for the video function. That is, video may be expanded to cover the entire desktop 210, or may be expanded and resized to cover a portion of desktop 210 specified by the participant. This expansion and resize function may also be utilized by other functions provided by communications OS 10, such as the reading of written content or listening to audio.

Referring again to FIG. 4, whiteboard area 430 has several active conversations windows represented as conversation windows 427, 428, 429, and 433. In the embodiment of the present invention shown in FIG. 4, the current participant is engaging in several different conversations with different participants. For instance, the current participant is engaging in a conversation in conversation window 427 wherein the participant is asking Bob and Tom whether the proposed conference schedule is acceptable. In conversation window 428, the current participant is engaging in a business or company oriented conversation on the design of a product. In larger conversation window 433, the current participant is interfacing with multiple other participants in a virtual company meeting. The other participants to larger conversation window 433 may be shown in a participants list 416. These other participants are part of conversation window 433 and may also interact and add to the conversation taking place within larger conversation window 430. As an additional function to the conversation capabilities of communications OS 10, the current participant may specify an additional, private conversation window 429 that may be considered a subset of a larger conversation, such as larger conversation window 433. In private conversation window 429, a smaller subset of the participants to larger conversation window 433 may converse privately, without the conversation being known or available to the participants of larger conversation window 433. In addition, participants to the private conversation window 429 may also invite other participants from outside the participants list 416 to join the private conversation. Thus, as can be seen in private conversation window 429, the conversation includes the current participant as well as participant A of larger conversation window 433. However, participants F and G are not a part of larger conversation window 433, but rather have been added to the private conversation window 429.

Each of the conversation windows active within whiteboard area 430 may be occurring in real-time. That is, conversations are fluid over time, and participants may join or leave as necessary or desired. Thus, the current participant may join a conversation already in progress and review the history of the conversation using a history option 424 in order to fully apprise himself or herself of what has already taken place in order to more effectively add to the conversation. To facilitate this real-time aspect of the conversations supported by the present invention, communications OS 10 may provide for real-time recording of conversations taking place within whiteboard area 430. As a result, history option 424 may provide functionality for the participant to easily review the history of a conversation. For textual conversations, the history option 424 may provide for scrolling through the text of the conversation, and may provide for search functionality. For audio and video based conversations, history option 424 may provide a playback controls for the current participant to rewind, fast forward, and playback any previously recorded content from the audio, video based conversations. Furthermore, the history option 424 provides the current participant with the option of stopping an ongoing, real-time conversation in order to attend to other matters, and then be able to return to the conversation at a later time, and instantly be resynchronized with the ongoing conversation. A participant may also choose to delete certain sections or segments of a previously recorded conversation, or may choose to delete an entire recorded conversation relegating it to the calendar at that time. Thus, other participants that are currently engaged in an ongoing conversation in real-time may have an icon next to their avatar denoting that the particular participant is actively participating. Participants that are not currently participating in the conversation in real-time or synchronized with the current conversation, but may be reviewing the history 424 of the conversation in order to get “caught up,” may have a different icon next to their avatar. Participants with a third icon next to their avatars may denote that the particular participant is unavailable for the current conversation. To illustrate the calendar in this scenario, the dates associated in this example, 2/29, 3/22, 4/12, and 4/26 next to the history 424, represent a few important moments of this ongoing interaction. Touching one of these dates may bring a participant back to that current moment in time. Thus, the calendar gives a full spectrum of access, these dates represent shortcuts to specific moments in the past.

As the current participant interacts within conversations located in the whiteboard area 430, the communications OS 10 may appropriately update and shift the currently active interest 401, resources 420, or stuff 414. For instance, as a calendar entry pops up indicating a new event or occurrence for the participant, the participant may accordingly shift his interest from one to another. As previously mentioned, communications OS 10 provides an interest centric virtual environment for the current participant. Therefore, as the current interests and concerns 20 shifts as a result of some event or occurrence within a conversation, the attendant relationships and resources 30, and stuff 40 may accordingly be updated with resources and stuff relevant for the participant's new active interest.

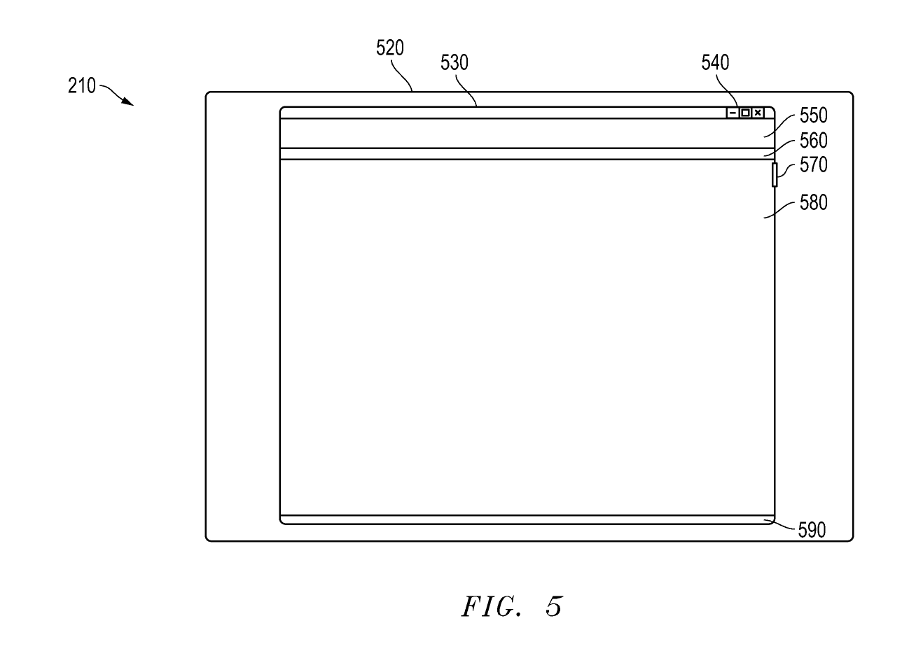

Referring to FIG. 5, there is a shown a virtual environment or more commonly known as a desktop 210 of the communications OS 10 of the present invention. The desktop 210 may be the primary interface for the participant to interact with communications OS 10, and its corresponding elements. While communications OS 10 may be embodied as a software program that may be executed and run within a traditional operating system software including but not limited to the Microsoft Windows operating system, Google Android, or Apple iOS, communications OS 10 may also exist as a stand-alone operating system that provides the virtual environment for participant interaction on electronic devices. Thus, communications OS 10 is not limited to a particular embodiment of desktop 210 as presently disclosed in the preferred embodiments, but may exist in a number of forms or formats compatible for electronic devices capable of running communications OS 10.

In FIG. 5, Desktop 210 allows for the participant to interact within the virtual environment of the present invention regardless of whether the viewing environment is a portable or stationary structure. Desktop 210 may be customized depending on whether the participant is an individual or an organization. Desktop 210 may comprise an interaction environment 520, where all conversations, activities, media, etc. may occur. Desktop 210 may further include interaction title bar 530. Interaction title bar 530 may specify interaction details. Part of what is displayed may be the interest and concern, project, if any, as well as date and time. Desktop may also include interaction window controls 540, which may either minimize, maximize, or close the present interaction environment 520 completely. A list of participants 550 may appear within the interaction environment 520. Participants may be illustrated by a placeholder, picture, icon, or live video. Interaction environment 520 may further include a menu 560 which may control features available to the participant. This may include an assortment of instructions that can range from normal menu concepts from word processing, drawings, etc. The menu 560 may be intuitive and alternatively based on the element of the interaction that the participant is currently engaged with. Interaction environment 520 may also include scroll control 570 which provides the participant with the capacity to scroll through the interaction environment 520. Scroll control 570 may allow the participant to scroll horizontally as well as vertically. Interaction pane 580 may be located within the body of interaction environment 520. Interaction pane 580 is where interactions take place, for example, television programming or movies. Interaction pane 580 is essentially the whiteboard area 430 and interactions and activities section 51 previously referenced. For interactive conversations, interaction pane 580 serves in multiple ways, for example, in the capacity of texting, drawings, pasting objects and pictures and templates and etc., as participants engage in the interactions. Interaction controls 590 may be an area of interaction environment 520 that may provide for an assortment of controls, for adding new distinctions, or new interests and an assortment of aspects for controlling interactions within interaction environment 520.

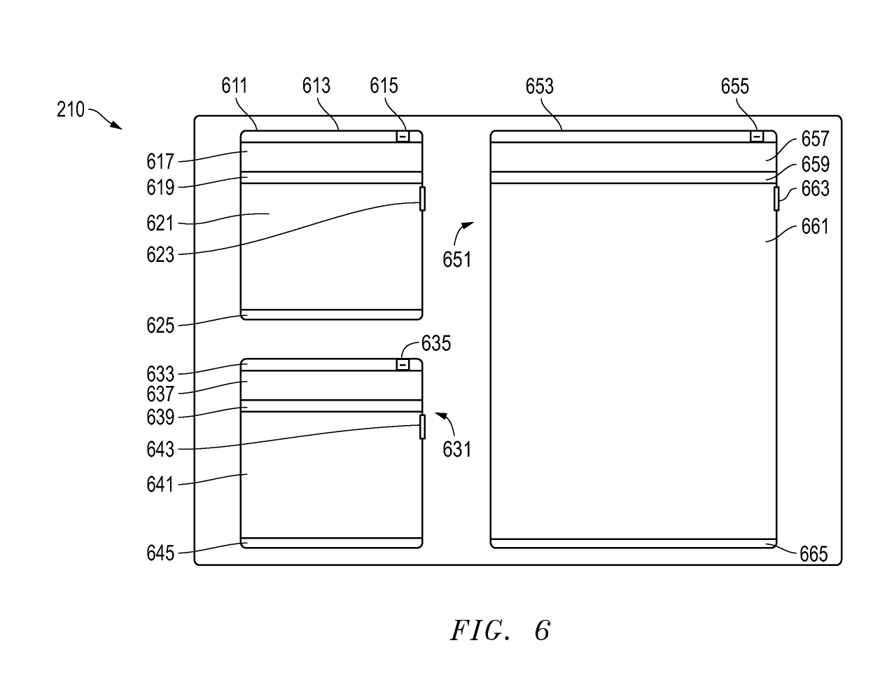

Next, referring to FIG. 6, another detailed embodiment of desktop 210 of the communications OS 10 is shown. Desktop 210 is shown populated with several windows representing the various elements of the communications OS 10 of the present invention. Each of the discrete elements may occupy an interaction environment 520 as described in FIG. 5.

In the embodiment of the present invention shown in FIG. 6, an interests and concerns window 611 is located in the upper left of the desktop 210. Interests and concerns window 611 may comprise a title bar 613, a window control 615, a potential space 617, a menu 619, a project list 621, a scroll control 623, and interests and concerns window controls 625. Title bar 613 may indicate the current interests and concern 20 that is currently at issue. Window controls 615 may allow the participant to reduce the interests and concerns window 611 to an icon. Potential space 617 may be used for an assortment of possibilities, such as: a place for requests for other participants to be integrated into the communications OS 10. Menu 619 may be used for many different aspects such as detailing projects that exist within specific interests. Project list 621 may provide a list of all interests, concerns and other projects. Scroll control 623 may provide the participant with horizontal and vertical scrolling capacity, similar to scroll control 570 described previously. Interest and concerns window controls 625 may provide for specific controls for interests and concerns window 611.

Next, a relationships and resources window 631 may be located in the bottom left section of desktop 210 as shown. Relationships and resources window 631 may comprise a title bar 633, window controls 635, potential space 637, a menu 639, a resources list 641, scroll control 643, and relationships and resource window controls 645. Title bar 633 may indicate the relationships and resources 30 available based on the interests and concerns 20 that are currently at issue. Window controls 635 may allow the participant to reduce the relationships and resources window 631 to an icon. Potential space 637 may be used for searches or details for the current person or resource selected. Menu 639 may provide a menu for the relationships and resources window 631. Resource list 641 may provide a list of persons, and may portray a picture or even a video of the person, particularly if they are unavailable. Resource list 641 may indicate the persons' availability, either underneath or beside their image, or when rolled over or passed over in the form of a balloon type of message. Scroll control 643 provides the participant with horizontal and vertical scrolling capacity, similar to scroll control 570 described previously. Relationships and resource window controls 645 may provide for controls to shift between persons and resources, internal, external and networked resources.

Additionally, a stuff window 651 may be located in the right side of desktop 210 as shown. Stuff window 651 may comprise a title bar 653, window controls 655, potential space 657, a menu 659, a relationships and resource list 661, scroll control 663, and stuff window controls 665. Title bar 653 may indicate the type of stuff 40 that is available within the current participant environment. Window controls 655 may allow the participant to reduce the stuff window 651 to an icon. Potential space 657 may be used to limit the specific stuff involved, such as by filtering or reducing the quantity via searches or filtering rules. Menu 659 may provide a menu for the stuff window 651. Stuff 661 may include a selection of stuff such as plans and calendars, lists of interactions, relationships, interest and concerns phrases, templates, systems and the like. Scroll control 663 provides the participant with horizontal and vertical scrolling capacity, similar to scroll control 570 described previously. Stuff window controls 665 may provide for various available controls that are dependent upon the type and categories of stuff presently available.

Windows 611, 631, and 651 do not have to be located in static positions on desktop 210, but may be placed in various locations within desktop 210, as controlled by the participant. Windows 611, 631, and 651 may also be adjusted and resized according to the participant, in order for certain windows to occupy differing amounts of desktop space on desktop 210. As previously mentioned, the use of window controls may further allow the participant to minimize each of the aforementioned windows into a representative icon, or may allow the participant to close a particular window.

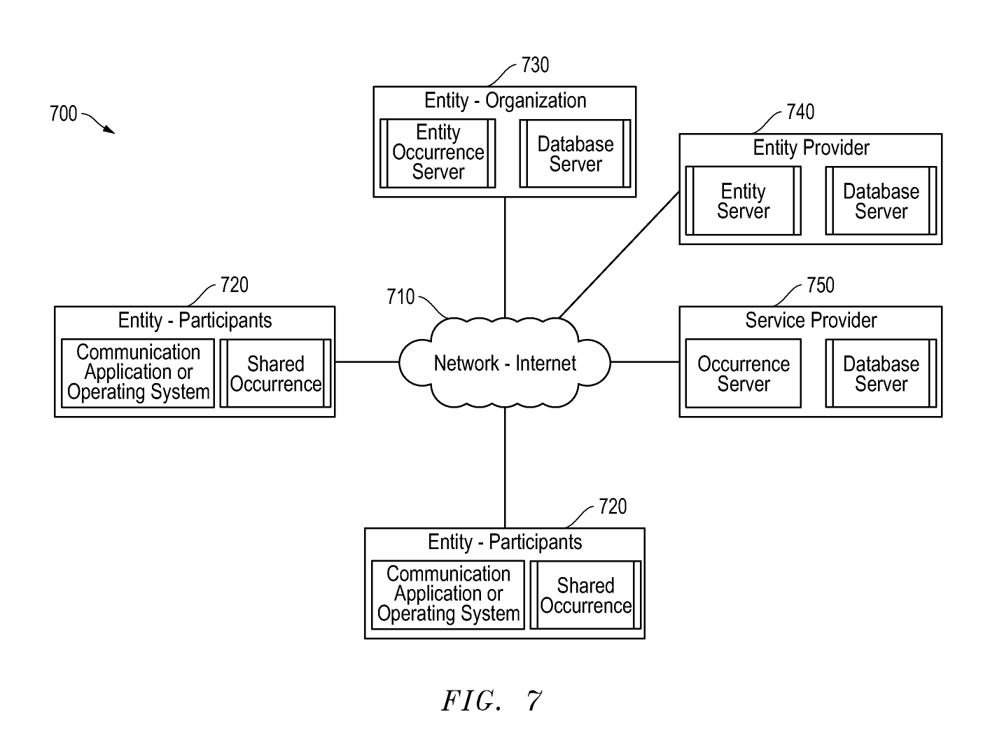

Now turning to FIG. 7, a block diagram of a communications network 700 is shown illustrating how two distinct participants may interact by utilizing the communications OS 10 of the present invention. In order for a participant to fully utilize the capabilities and features provided by the communications OS 10, the participant's electronic device may connect to a communications network 700 for access to servers and databases that further enrich the participant's virtual environment.

Communications network 700 may comprise of one more of the following: entity participants 720, entity organizations 730, entity providers 740, and service providers 750. Communications network 700 may be interconnected via a network 710 such as LAN, WAN, the internet, or any other suitable network connection. In this manner, different entity participants 720 may have a shared occurrence over communications network 700, and that shared occurrence may exist at service provider 750 and/or an entity organization 730 as depicted in diagram. Entity provider 740 may include an entity server and a database server, with the entity server providing controls for the look and feel of the communications environment on the participant's electronic device, applications, functionality, and influences the look and feel of the interactions taking place on the participant's desktop. In other words, the entity server and its corresponding database server provides for a unique identity and experience for each participant, an intelligence, an entity profile and may also provide for a catalog of all the interests, interactions and structure of the participant or entity. Functionality such as the authentication of the participant, the learning of the participant's interests and concerns 20 over time, and the determination of what specific relationships and resources 30 as well as stuff 40 is appropriate for a given interaction is facilitated by the entity server.

Service provider 750 may include an occurrence server as well as a corresponding database server. The occurrence server provides for the occurrence available on the desktop of a participant's electronic device. That is, what occurs on the screen of a participant's electronic device is facilitated by the occurrence server. Together with the database server available within the service provider 750, the occurrence server may transmit data to the participant's electronic device in real-time, based upon the then occurring interactions that take place on the participant's electronic device. In this manner, the electronic device does not need to store data locally for an interaction, but may receive data or update the current data to reflect or instigate changes to the occurrence server to further participant activity. However, the electronic device may temporarily store occurrences in which real-time changes reflect and coordinate the moment-to-moment alteration of the occurrence, as activities by any participants of the communications OS 10 would be reflected in these real-time changes.

Entity organization 730, entity provider 740, and service provider 750 may each maintain data on a current existence of a shared occurrence in a database server, and all historical aspects of this interaction or shared occurrence is maintained over time in the database server. As a result, data for the communications OS 10 to fully operate need not be stored locally on the electronic devices, but may reside purely on the database servers available with entity organization 730, entity provider 740, and service provider 750. In other embodiments, data for communications OS 10 to operate may reside both locally on the electronic device as well as on database servers. In yet other embodiments, data that resides on the electronic device and on the database servers may be mirrored, held statically or permanently on the servers. During use and interactions with the electronic device by a participant, the electronic devices as well as entity provider 740, and service provider 750 communicate over communications network 700 in order to facilitate the virtual environment experience for the participant. Each entity participant 720 may also have environments specific to them and no one else. The specifics of the entity participants' 720 environment is consistent over time, and is developed over time in such a way that all the interests and concerns 20, relationships and resources 30, and stuff 40 are held in a database server for the entity participant 720 with a corresponding entity provider 740.

Remaining on FIG. 7, the figure illustrates that there is interconnectivity among multiple locations in such a way as it occurs as a cloud environment and therefore the physical location of servers and providers is completely transparent to various entity participants 720. It further illustrates that entity participants 720 may have a novel type of namespace that may serve as an unique identifier for the entity participant 720 within the communications OS 10, and may also be used as a relative identifier for an entity isolated to some central network of entity providers 740, which is distinct from the rapidly altering communicative and/or service provisions. It is this network of entity providers 740 and service providers 750 that empower interactions, activities and the like. Therefore, the present invention may support multiple different types of networks 710, such as wired, wireless (“wifi”), microwave, satellite, and other suitable networks that allow stationary and mobile electronic devices to connect.

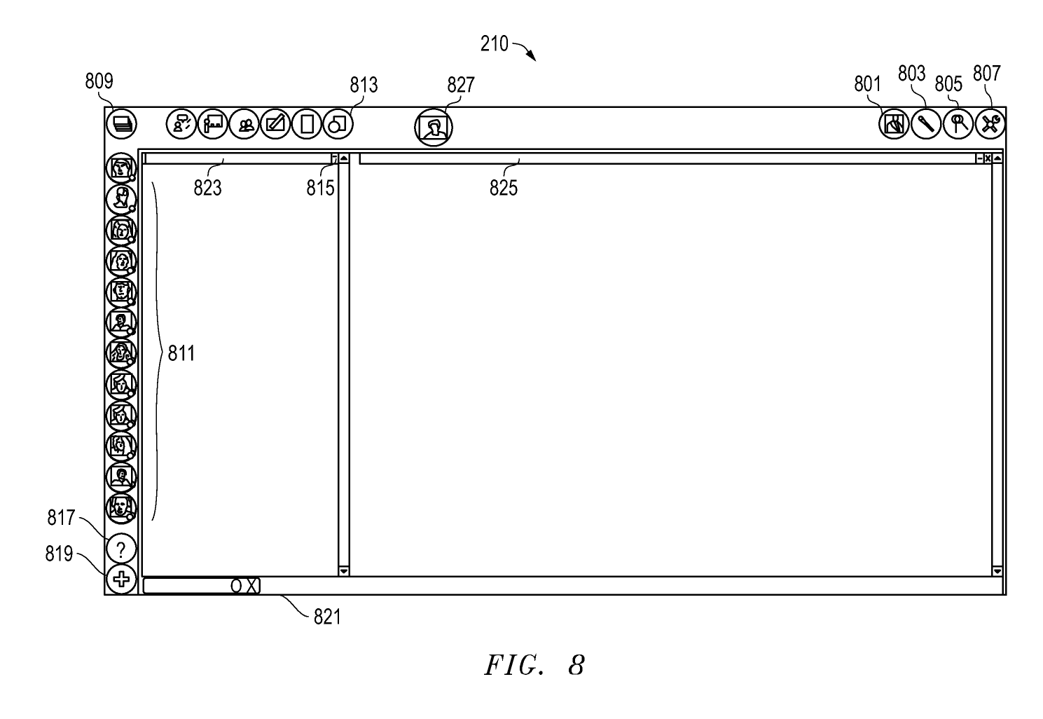

Turning to FIG. 8, yet another embodiment of the desktop 210 of the present invention is shown. In this embodiment, desktop 210 as previously disclosed is illustrated as containing various interactive buttons and panes for participant and entity interaction. In this embodiment of the present invention, desktop 210 may contain an avatar 801 which represents the current participant. Avatar 801 may further be used to represent the current status of the participant, as well as the participant's availability or desire for privacy. Touching or clicking avatar 801 may offer further interaction options. Several additional features may also be made available to the participant by way of selecting items that are available within stuff 40. For example, the references 801, 803, 805, and 807 are all items that may be derived from stuff 40.

The current status 803 of the participant may be manually selected. Some different statuses may include: do not disturb, not available, idle, available, text only, text and audio, text, audio and video. Current status 803 may be based on: per interest, per resource, per conversation basis. Controls 805 and settings 807 permit others participants to view the current use participant's status, availability and the like.

Controls 805 may allow for the adjustment of various interactivity functions related to the particular embodiment of desktop 210 shown in FIG. 8. For instance, current conversations 821 may be adjusted. Settings 807 allow for personalization and configuration of desktop 210 for each individual participant. Each participant has complete access to how their desktop 210 is organized and how it appears. Settings 807 for each type of device become available by the setting designed for the different mediums. Interests and concerns icon 809 sets desktop 210 up as resources and relationships 811 changes according to changes in the current interest. Furthermore, as the current interest of the participant changes, so does the current stuff 823.

Relationships and resources 811 demonstrates a list of icons, each of which is associated with one or more interests of the present participant. That is, only resources, persons and relationships 811 pertinent to the present participant's interests 809 will be displayed. Additionally, stuff 813 that is pertinent to the present conversations 821 may be displayed. Stuff 813 may be managed via appointments and a calendar. The way that interests, resources and relationships, stuff and conversations appear may be changed via an appearance icon 815. In the particular embodiment, the “-” shown in FIG. 8 indicates changing the current presentation to an icon or miniature format, while “o” enlarges it to a viewable presentation and “x” makes it disappear. In the bottom left of desktop 210, there may be located a requests icon 817, which displays requests from other participants who are not a current contact but may wish to have a conversation with the current participant. If the request is accepted, the current participant may add them to the current network. Additionally, the current participant may elect to just keep the conversation available until the current participant chooses to terminate it. Next, an add new item icon 819 may allow the current participant to add a new conversation, resource, stuff or interest. Add new item icon 819 may also let the participant remove an item. In some organizational settings, the current participant may have some relationships, resources, work interests and projects as part of an employment agreement. There may be some capacities for oversight and monitoring as part of the current participant's work environment.

Next a stuff menu 823 may be provided wherein different menus for different types of stuff 40, for different interests and different varieties of stuff for specific type and interests may be displayed. The selection of stuff 40 displayed may be based on personal preferences. A conversation and activity menu 825 may further be provided which provide different menus for different conversations, activities and temporal aspects for each moment, as different interests and different varieties of conversations, activities and interests arise. What is displayed by the conversation and activity menu 825 depends upon personal preferences for the current participant. For instance when watching a movie, the conversation and activity menu 825 may present buttons to pause, advance, rewind. A list of participants 827 may be located above the conversation and activity menu 825. The list of participants 827 may include those participants on the current participant's contact. The list of participants 827 may also include those participants not on the current participant's contact list but currently conducting a conversation with the current participant as a result of a sent or received conversation request. The participants 827 may be represented as avatars, a picture or a video depending on the choice of the participant 827. The size of the video may also be adjusted.

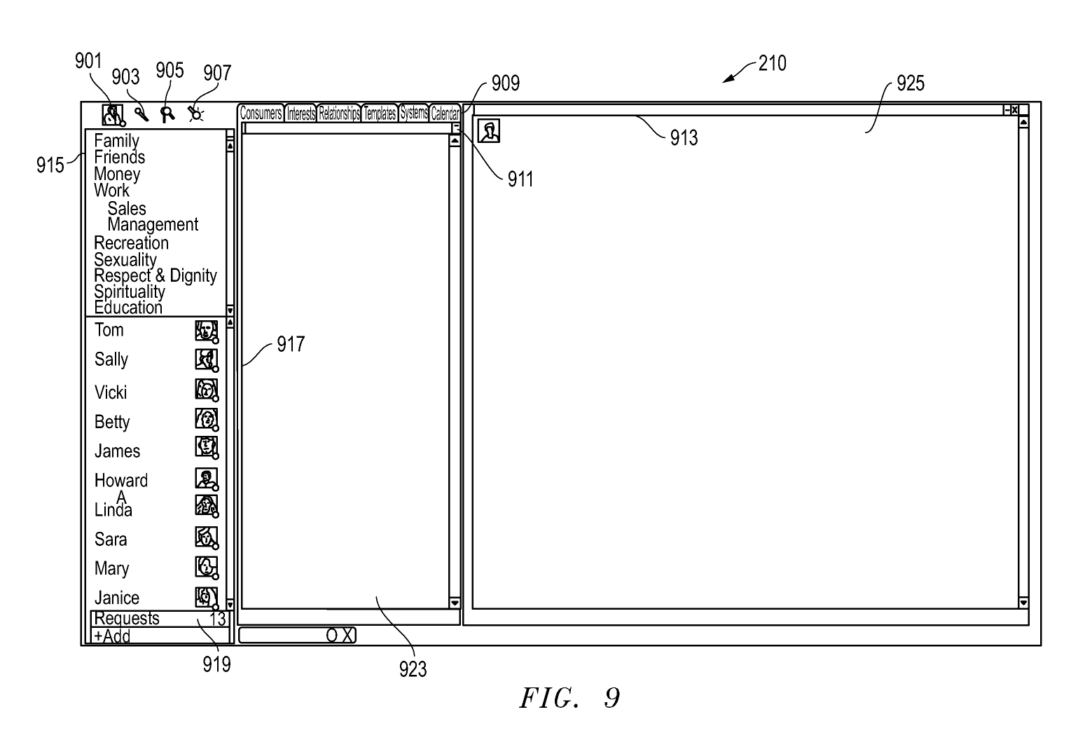

Turning to FIG. 9, another preferred embodiment of the present invention is depicted. Similar to the embodiment shown in FIG. 8, a desktop 210 is illustrated as containing various interactive buttons and panes for participant and entity interaction. In the embodiment shown in FIG. 9, desktop 210 may contain an avatar 901 used to represent the current status of the participant, as well as the participant's availability or desire for privacy. Touching or clicking avatar 901 may offer further interaction options. In the particular embodiment shown, avatar 901 may further display the status of the participant, and may constantly change as each interaction occurs. The appearance and function of the environment displayed on desktop 210 may be adjusted using controls and settings provided.

As in FIG. 8, several items that may be available to the participant may be derived from stuff 40. Such items may include references 903, 905, and 907, among others. The current status 903 of the participant may be manually selected. Some different statuses may include: do not disturb, not available, idle, available, text only, text and audio, text, audio and video. Current status 903 may be based on a: per interest, per resource, per conversation basis. Controls 905 and settings 907 permit others participants to view the current participant's status, availability and the like.

Controls 905 may allow for the adjustment of various interactivity functions related to the particular embodiment of desktop 210 shown in FIG. 9. Settings 907 may also allow for personalization and configuration of desktop 210 for each individual participant. Each participant has complete access to how their desktop 210 is organized and how it appears. Settings 907 for each type of device become available by the setting designed for the different mediums.

A selection of stuff 909 may be provided on the desktop 210. Depending on the particular stuff 909 currently selected, a stuff menu 911 may be provided which provide different menus for different types of stuff 40 dependent upon different interests and concerns 20. The stuff menu 911 maybe designed and adjusted based upon the participant's personal preferences. Additionally, based on the current conversation or interaction the participant has selected, a conversation and activity menu 913 may appear on the right side of desktop 910. Conversation and activity menu 913 may provide different menus for different conversations, activities and temporal aspects for each current participant, as different interests and concerns 20 and varieties of conversations, activities and interests arise. Conversation and activity menu 913 may be designed upon each individual participant's personal preferences.

An interests and concerns list 915 may be placed on the left hand side of desktop 210. The interests and concerns list 915 provides a list of relevant interests and concerns to the current participant depending on the current interest or status based on avatar 901. The items in the interests and concerns list 915 may change as the current participant's interest changes, according to avatar 901. Below the interests and concerns list 915, a relationships and resource list 917 may be provided. Relationships and resource list 917 provides a list of other participants related to the current participant's current interest scenario. Thus, a change in the current status of the participant may effect changes to the stuff 909 and stuff menu 911, as well as the interests and concerns menu 915 as well as relationships and resource list 917. Below relationships and resource list 917 may be located a requests section 919 which may display a number of requests from other participants.

Below the resources and relationships menu 917, there may be located a requests icon 619, which displays requests from other participants who are not a current contact but may wish to have a conversation with the current participant. If the request is accepted, the current participant may add them to the current network. Additionally, the current participant may elect to just keep the conversation available until the current participant chooses to terminate it. On the bottom of desktop 210, interests and concerns 20 and stuff 40 may be minimized.

A stuff content window 923 is placed adjacent to the interests and concerns list 915 and relationships and resources list 917 and contains content of the selection of stuff 909. Selection of stuff 909 may be constantly updated with additions and changes, and also may change depending on further changes in relation to the other menus provided. Adjacent to the stuff content window 923 is a conversation window 925 which may contain a variety of conversations currently participated by the current participant, whether or not originally initiated by the current participant. Each conversation within the conversation window 925 may exist as a whiteboard that may support various modes of communication such as text, audio recordings, video, and any other means to communicate. Such communication means may include but are not limited to texting, spreadsheets, databases, translations, voice to text conversions, contracts, agreements, requests, setting appointments, reminders, processes, searching or looking for places, GPS, maps. As the participant interacts in conversation window 925, stuff 909 may be added, removed, and otherwise manipulated. Thus, conversation window provides an environment that has a historical memory of everything that happens in sequence.

The current participant as well as other participants within the current participant's network may drag and drop aspects of stuff 909 into conversation window 925 in order to limit or expand the conversations. Stuff menu 911 therefore changes depending on the type of stuff 909, activity or interaction taking place at the particular moment and the interest involved. The activity or interaction taking place at a particular moment may be adjusted by the participant using controls 905 and settings 907. Conversations may progress and change over time, permitting participants to be added and removed as these changes occur. Thus, it may be possible for conversations to remain active for an extended period of time. As an example, the participant may utilize communication OS 10 to maintain their own health records permitting different doctors to access their records. Therefore, no explicit transfer of information by the participant to other participants is needed in this environment. Over a lifetime there might be only a dozen centralized conversations regarding “health” where doctors, nutritionists, dentists, fitness coaches, and specialists are from time-to-time added and removed from the different conversations. This eliminates duplicative and potentially conflicting records from multiple sources. The historical creation and deletions of these conversations may be reviewed, recaptured, searched for, and otherwise used as necessary and authorized by the participant.

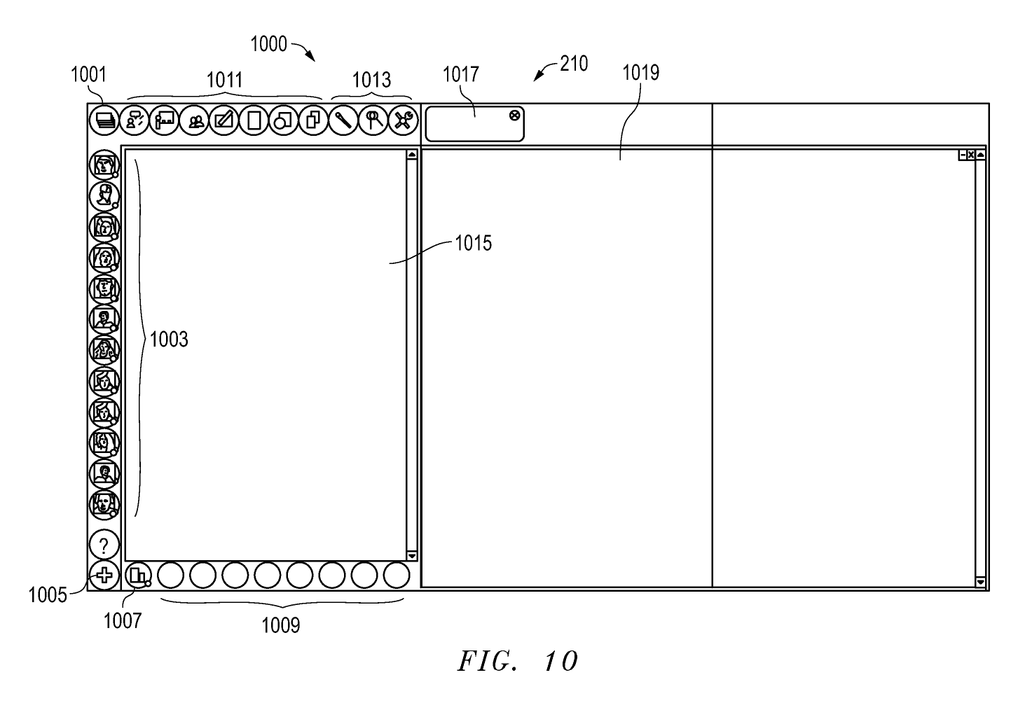

Turning now to FIG. 10, an embodiment of the present invention utilizing a tri-folding mobile device 1000 is shown. The tri-folding mobile device 1000 may allow for operation as a simple mobile unit that may open to a fully functional tablet or notebook type capability. The tri-folding mobile device 1000 may exist as two screens of which the second screen has the capability to fold, or it may exist as a single screen having the capability to fold twice. Communications OS 10 may provide settings and controls to operate tri-folding mobile device 1000 as a simple mobile device or as a fully functioning tablet.

Tri-folding mobile device 1000 may contain an interests and concerns icon 1001 in the upper left corner of a desktop 210. A list of resources and relationships icons 1003 may populate the left side of desktop 210. Each distinct icon 1003 may be associated with one or more interests that may be presently active as shown by the current interests and concerns icon 1001. The only resources and relationship icons 1003 that may appear are ones associated with the currently selected interest and concern 20. Below the list of resources and relationships icon 1003 lies an add new item button 1005. Add new item button 1005 allows the current participant to add other participants to a conversation in an area of interest. The other participants may or may not be in the current participant's contacts. When the other participants are not currently associated with the current participant, either through the contact list or area of interest, they may be displayed in the add new item button 1005. The current participant may then choose to accept the conversation, add the other participant to the current participant's contacts, or ignore the request. In addition, other items may be added via the add new item button 1005. Such other items may include new interactions and activities 50, stuff 40, or interests and concerns 20.

Adjacent to the add new item button 1005 may be an avatar 1007 that represents the current participant. Avatar 1007 may be a picture or video of the current participant, depending on the choices and settings selected, as well as the current status of the current participant. A set of mobile controls 1009 may be placed next to avatar 1007 to facilitate interaction between the current participant and the desktop 210 of the tri-folding mobile device 1000. Mobile controls 1009 may provide the current participant with various options to the current desktop 210. A selection of stuff 1011 may be placed adjacent the top of the desktop 210.

In the current stuff window 1015, items relevant to the selection of stuff 1011 may be displayed, such as conversations, interests, projects, relationships, templates, systems and calendar. The items appearing in the current stuff window 1015 may be based on the current participant's interest, and modified by controls and settings 1013, again as with FIGS. 8 and 9, may be based upon stuff 40. Next to the current stuff window 1015, a conversation window 1019 may be located. Conversation window 1019 may contain a variety of conversations currently participated by the current participant, whether or not originally initiated by the current participant. Each conversation within conversation window 1019 may exist as a whiteboard that may support various modes of communication such as text, audio recordings, video, and any other means to communicate. Such communication means may include but are not limited to texting, spreadsheets, databases, translations, voice to text conversions, contracts, agreements, requests, setting appointments, reminders, processes, searching or looking for places, GPS, maps. As the participant interacts in conversation window 1019, selection of stuff 1011 may be modified by adding, removing, and otherwise manipulating the list. Thus, conversation window 1019 provides an environment that has a historical memory of everything that happens in sequence. Above the conversation window 1019 resides tabs 1017 representing conversation windows which may be minimized via minimize conversation button.

Controls and settings 1013 may be provided on the desktop 210 of tri-folding mobile device 1000 and may allow the participant to modify the current status. Statuses that may be available to the current participant may include: do not disturb, not available, idle, available, text only, text and audio, text, audio and video. These statuses may be based on a per-interest, per-resource, or per-conversation basis. Controls and settings 1013 may further permit other participants to view the current participant's current status, availability and other information. Controls and settings 1013 may also provide colors or symbols or whatever means chosen to illustrate resources and the current participant's current or future status. Controls and settings 1013 may also allow adjustment of the active current stuff window 1015 and conversation window 1019, such as rolling back and rewinding a conversation. Each participant of tri-folding mobile device 1000 may have complete access to how their personalized desktop 210 is organized and its appearance. Settings for each type of device become available by the setting designed for the different mediums.

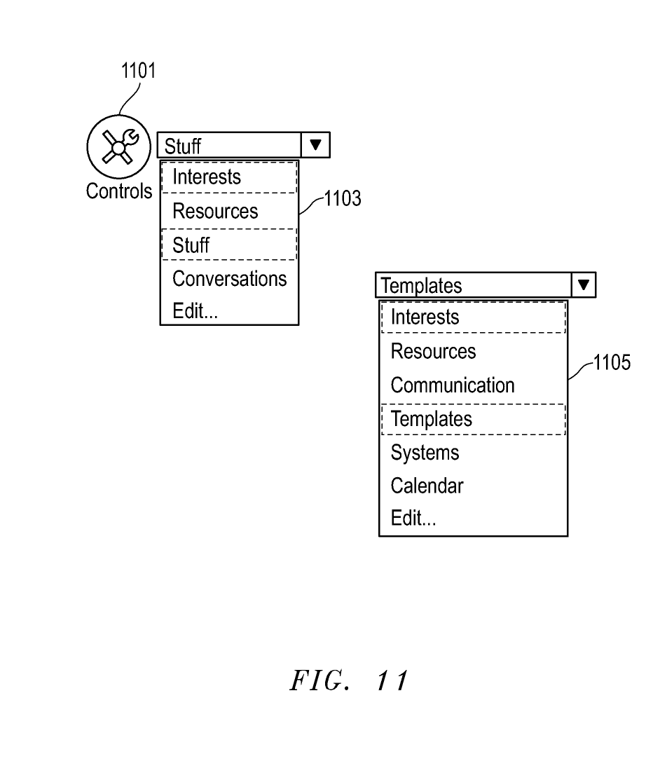

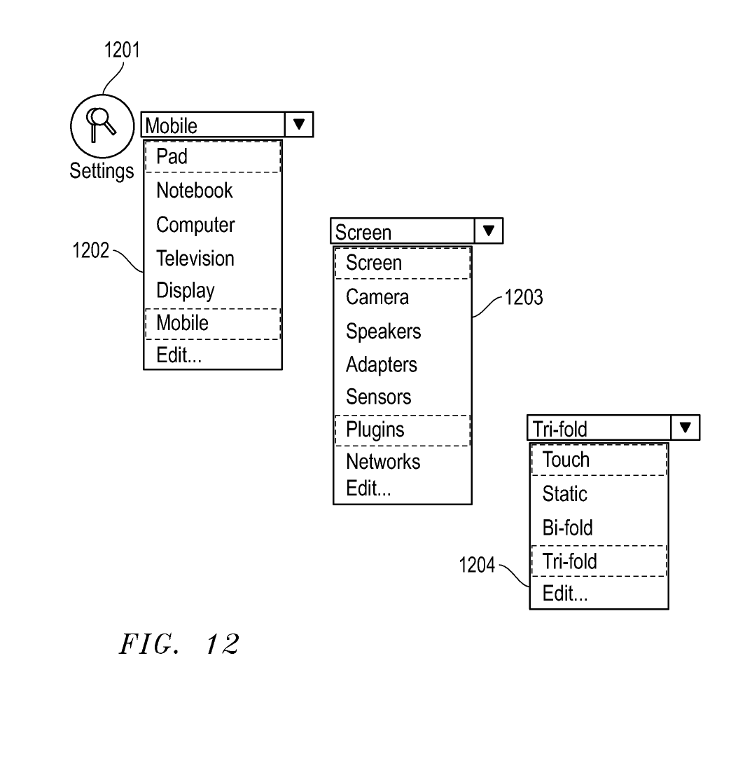

Referring now to FIG. 11, therein is shown an embodiment of a graphical interface for adjusting or configuring various functions within the communications OS 10. With regards to the present invention, there may typically be four aspects: Interests, Resources, Stuff and Conversations. Each of these participant-oriented aspects may have their layout and appearance adjusted by a controls 1101. Accordingly, controls 1101 may correspond to the controls 805, 905, and 1013 shown in FIGS. 8, 9, and 10 respectively. However, other variations and implementations of controls 1101 may be setup by the participant, and does not have to be limited to the implementations shown in FIGS. 8, 9, and 10. Thus, controls 1101 permit every aspect to be configured and designed relative to each individual participant. Furthermore, FIGS. 11 and 12 show embodiments of how controls 1101 may be implemented through stuff 40, but other various embodiment may also be possible. Controls 1101 may further contain embodiments which are device oriented and may adjust hardware settings on the electronic devices themselves. While there may be certain aspects that are set by each organization, each employee participant may design each aspect to their own specifications, preferences and design. Furthermore, the design of controls 1101 maybe modified over time, as the environment learns or anticipates the actions of the participant as the participant interacts with other participants and the environment.

Controls 1101 may provide a way to create or alter the design of a structure, appearance (location and placement), capacities, alarms, and preferences of the environment, interests, resources, stuff and conversations. Areas that may controlled include the public persona of a participant for different interest and concern personas. The current participant may be recognized or hidden from the public by taking into account all interests and/or specific interests. Controls 1101 may also be accessible from both public locations as well as within different networks of interest, with the only restrictions occurring from negotiated terms of employment, partnerships and other agreements. For instance, as in the earlier example involving the hypothetical participant, the participant may be able to access controls 1101 while utilizing a personal electronic device, such as a tablet. However, the hypothetical participant may also choose to access controls 1101 when he was driving his car on the way to the meeting, or even access controls 1101 while in the elevator going up to the meeting.

Upon interaction with controls 1101, the current participant may be presented with a general control menu 1103 that may contain a list of basic structures, including the elements, domains, or areas of an environment. The basic structures may be altered, deleted, or added to. The permutations for these basic structures may include both automatically designed basic structures such as interests, resources, stuff, and conversations, as well as specialized elements that do not easily fit within an automatically designed basic structure. At the root level, interests and concerns 20 help to determine the structures available within a particular interest. In the example shown in FIG. 11, in general control menu 1103, the “interest” has at least “resources”, “stuff”, “conversations”, and “edit structures” available to the participant. In addition to general control menu 1103, a specific control menu 1105 may be provided which allows the participant to modify the behavior of certain general structures relating to each element, domain or area of the environment. FIG. 11 is a mechanical representation representing two (of several) levels of design simply to demonstrate the flexibility for controls 1101 and is not limited to any specific methodology or design.

Next, at FIG. 12, there is shown a graphical interface for adjusting settings 1201 for the electronic device used to access the communications OS 10. The present invention is typically embodied as a communications OS 10 running on an electronic device, with various hardware aspects typically associated with each electronic device. Thus, the communications OS 10 provides for a participant to adjust the settings 1201 of the various hardware aspects of a selected electronic device. As with controls 1101, settings 1201 may correspond to the settings 807, 907, and 1013 shown in FIGS. 8, 9, and 10 respectively. However, other variations and implementations of settings 1201 may be setup by the participant, and does not have to be limited to the implementations shown in FIGS. 8, 9, and 10.

Settings 1201 may provide the participant a device selection menu 1202. Thus, a participant may adjust or alter the settings for one specific electronic device at a time. In the device selection menu 1202 shown, the participant may be able to select between different categories of devices, such as a tablet, notebook, computer, television, display, mobile, or other device. Although not shown, the device selection menu 1202 may also incorporate specific manufacturers of devices as well as device models. In the example shown, the participant has selected a mobile device. Next, after an appropriate device has been selected from device selection menu 1202, the participant may select the specific hardware component that the participant wishes to adjust settings for at the component selection menu 1203. In the example shown, the participant has selected the screen of the mobile device for adjusting settings 1201. Depending on the initial device selected, the options available on the component selection menu 1203 By way of example and not excluding any other components, component selection menu 1203 may also provide selections for cameras, microphones, speakers, adapters, sensors, plugin devices, and networks. Next, in configuration menu 1204, the participant may adjust the configuration of each component available for a particular electronic device. By way of example only, and not limiting the options available for each component, the following components may be adjusted as follows: (1) the screen may be adjusted to allow for touch screens, static, bi-fold and tri-fold screens; (2) the camera may be adjusted to provide different resolutions, zoom level, and brightness; (3) the microphone may allow for mono or stereo input; (4) the speakers may allow for mono or stereo input; (5) adapters and sensors may allow for adjustment depending on the electronic device in use; (6) network settings may be changed between satellite, microwave, wi-fi, wired. FIG. 12 is simply a mechanical representation of varying levels of design possible that demonstrates the flexibility for settings 1201, and is not meant to limit embodiments of settings 1201 to any specific methodology or design.

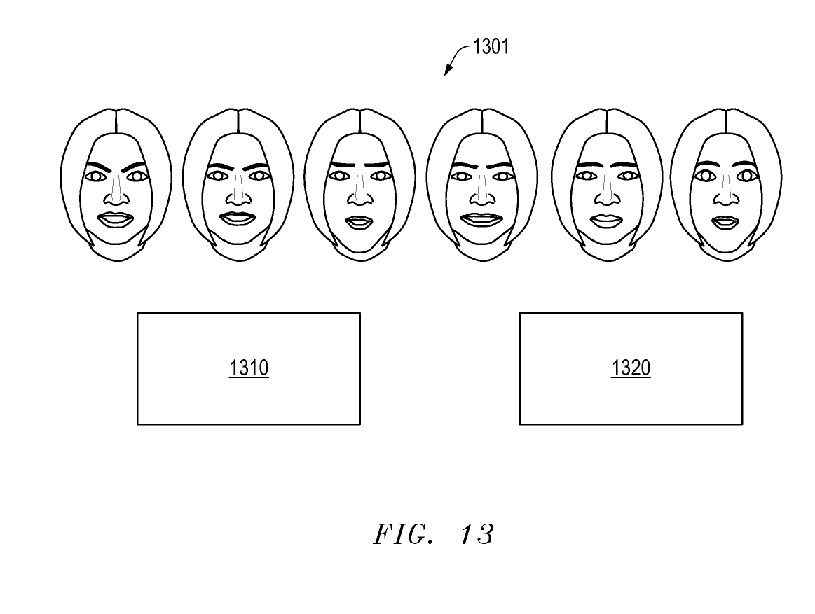

Turning to FIG. 13, a series of participant facial expressions 1301 that may be recognized by the communications OS 10 is shown. During the course of human-to-human communications and interactions, participants tend to rely on facial expressions to a large degree. Thus, when participants are aware or attuned to what these expressions tell them, the communications may become much more effective. Because communications OS 10 allows for the incorporation of audio/video into conversations and conferences, it may be desirable that the participant receive more useful feedback and awareness of his or her then current emotional state, as well as some speculative indication of the emotional states of other participants if desired.

The communications OS 10 of the present invention may further provide the ability to monitor and record the current emotional state of the participant and provide feedback regarding a participant's current emotional state in a meaningful manner. In this fashion, the participant may then become more self-aware of his or her current emotional statement as he or she is interacting with other participants through the communications OS 10, or during non-social activities conducted by the participant within communications OS 10. Communications OS 10 may support the use of cameras 1310 and sensors 1320 located on the electronic device to help capture the current facial expressions of the current participant. Camera 1310 may be a high resolution camera that is able to capture the participant's facial images as the participant interacts with the communications OS 10. Sensors 1320 may include other non-visual capture mechanisms, such as microphones for capturing the participant's voice, infrared sensors able to monitor body temperature, and sensors for monitoring various other participant conditions (such as electro-magnetic, biological/biometric and electro-static sensors).

Using camera 1310, the communications OS 10 may read the facial expression and muscle positioning of the current participant. Other details such as pulse, moisture, eye movement, pupil dilation, skin color, body temperature, as well as other visible factors such as perspiration, and eye conditions may also be captured by camera 1310 and sensors 1320. Further, electro-magnetic and electro-static sensors may capture other useful information regarding the electronic impulse signatures of the current participant and in turn use the captured information in some meaningful manner to provide feedback regarding the participant's condition. After camera 1310 and sensors 1320 provide the pertinent information to communications OS 10, the communications OS 10 may then parse the information into visible, audible, and/or touch sensitive feedback to the participant regarding the participant's current emotional state.

For instance, the feedback may simply be the screen of the electronic device displaying a different colored hue depending on the emotional state of the current participant (or other participants). Three such primary emotions that may occur in interactions may appear as love, aggression and discernment. If the current participant's current emotional state is of arrogance or egotism, such as if the participant was arguing a point upon which he had a firm belief, the screen may display in an orange hue. Aggression or anger, for instance when the participant is attempting to produce a certain intention or outcome, may be displayed as a red hue. A transcendent or tranquil state may be displayed as a blue hue. If the participant is in a state of discernment, for example if the participant was not aware, but lost within his own thoughts, the screen may be displayed in a yellow hue. Furthermore, the overall mood of the participant may also accordingly adjust the brightness (or darkness) of the screen. That is, if the participant is in a good mood or regards the current interaction as favorable, the display may subsequently become brighter, whereas if the participant is in a bad mood or regards the current interaction as unfavorable, the screen may then become darker. The color scheme used may be based on the preferences and needs (color blindness as an example) of the participant. Other methods of feedback for the participant may include haptic feedback such as vibrations emanating from the electronic device. Or, feedback may take on the form of sounds or music played back from the electronic device when changing from one emotional state to another, or when the participant is in a particular emotional state. The particular set of feedback mechanisms for the participant's emotional state may be adjusted or configured through controls similar to controls 801.

Thus, the present invention may provide feedback of a participant's current emotional state based upon feedback received from the participant's facial expressions, the participant's tonal inflections and biological reactions during speaking in a conversation, as well as the participant's choice of words used during the conversation. Together, these three aspects may provide the participant with a more full self-awareness of his or her emotional state at any particular time. The participant may also become more aware of his or her emotional state when others express themselves. The entity provider 740 learns the emotional structural changes of the participant and provides an intelligence for the participants moment-to-moment emotional characteristics. As a result, the participant may better understand his or her tendencies or habits during conversation, and may then choose to modify present conversation behavior as well as for future conversations. Overall, this results in better awareness and communication habits for the participant. Such behavioral modification may apply to the participant's conversational behavior whether communicating with others through an electronic device, or interacting with others in a traditional, face-to-face setting.

By using the facial recognition feature supported by the communications OS 10 in conjunction with other sensors 1320, the communications OS 10 may then intuitively and automatically shift the currently active interest or concern 20 of the participant to a more appropriate interest. That is, the communications OS 10 may read the participant's current facial expressions, word choice during a conversation, as well as the tonal inflections in the words being used in order to both determine the current emotional state of the participant, as well as adjust the currently active interest to a more appropriate interest. This may all occur in real-time without any manual input on the part of the participant. As an example, returning once again to the example of the hypothetical participant, if the participant were to become argumentative and frustrated during the meeting that he was attending, the electronic device in the meeting room would be able to capture the hypothetical participant's emotions as they occur and provide feedback at once, dimming the participant's screen as well as displaying a red hue. Thus, rather than the typical scenario where the participant is unaware that he is becoming more agitated and eventually having to be told by others to “calm down,” the communications OS 10 automatically provides feedback of such, and the participant would accordingly be able to reign in his emotions during his meeting. At the same time, communications OS 10 may also detect that the current participant's mood or emotion has become bored, tired or hungry, and accordingly switch the current interest for the participant to one that displays restaurant choices for his later dinner with his wife. It has been theorized that emotions shift before the participant is aware. The feedback mechanism available with the present invention may give the participant an early feedback of the altered emotional state. This awareness permits the participant to make various choices before the participant gets too invested in an emotional state. Sometimes this is referred to as emotional intelligence. This capacity can effectively raise the emotional intelligence of the participant.

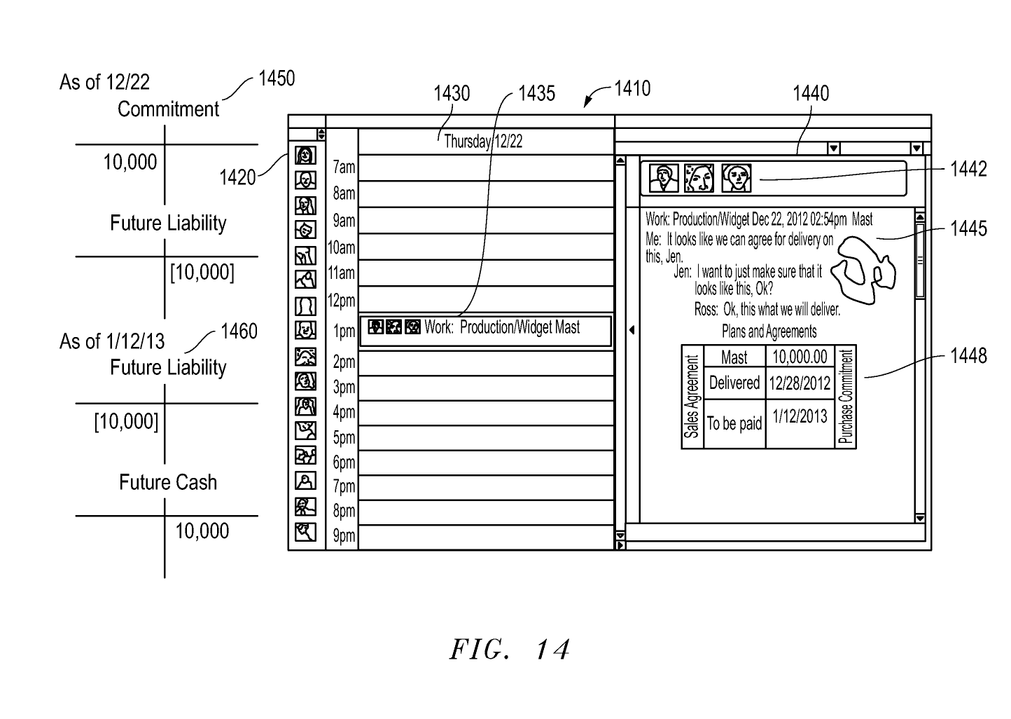

Turning now to FIG. 14, an embodiment of the desktop 210 of communications OS 10 is shown utilizing its accounting functionality. The communications OS 10 of the present invention may provide accounting functionality in similar fashion to the other features of the present invention, by providing many of the same interactivity options as in the other various embodiments, and may provide additional, accounting oriented interactivity functions. Thus, FIG. 14 provides both an embodiment as well as a hypothetical example of corresponding uses of current accounting conventions as a participant of the communications OS 10 engages in an interaction.

In the accounting embodiment shown in FIG. 14, a desktop 1410 of a participant of communications OS 10, and is otherwise denoted in FIG. 14 as “me.” Relationships and resources 1420 provides a listing of persons and resources that may be appropriate for a given current interest and project or interaction 1440. A daily calendar 1430 provides a calendar and assists the participant in keeping track of a current interaction 1440. A complete calendar view may be chosen that may provide and assist in tracking all of the interactions 1440, agreements and commitments historically related to the participant, as well as those that are scheduled for some time in the future. In FIG. 14, the calendar 1430 is displaying the calendar entries for Thursday, Dec. 22, 2012, which correlates to the interaction 1440 presently active on the participant's screen. A recent occurrence 1435 of the interaction 1440 appears as a specific entry on the calendar 1430. In this instance, recent occurrence 1435 shows that the interest and project is “Work: Production/Widget Mast”, which is to take place from 1:30 p.m. to 3:00 pm, on Dec. 12, 2012. The participants in this hypothetical interaction 1440 are the current participant himself “me”, Jen and Ross.

Specifically, recent occurrence 1435 shows that the interaction 1440 of Dec. 22, 2012 occurred from approximately 1:00 p.m. to 3:00 p.m. or at 2:54 p.m., and that interaction 1440 was with regard to the interest and concerns 20 “work.” Even more specifically, the interaction 1440 was about a project called “Production/Widget Mast.” In this example this is explicitly displayed in the interaction 1440 on a virtual whiteboard 1445. A participants list 1442 is shown within interaction 1440. Not only does this provide for a listing of participants actively associated with the interaction, but also provides for audio and visual conversations to occur during interaction 1440, similar in nature to the audio and visual capabilities described in FIG. 4.

Additionally, on the virtual whiteboard 1445, negotiations are engaged for a future sale/purchase along with terms and conditions on a virtual whiteboard. As the participants agree on of the conditions of the agreement, such as costs and delivery, a template 1448 is used as a purchase commitment that will be expressed in relation to the interaction participants as a sales agreement. According to the purchase commitment, the participants have agreed to transact for the purchase and delivery of one mast for $10,000.00, to be delivered to them on Dec. 28, 2012 and have agreed to pay (or enact a transfer of funds) for the mast on Jan. 12, 2013.

As can be seen by this example, a participant may create, reuse, obtain (from a third party) or inherit an item, and any participant may bring into the interaction a template relevant to the interaction in which all participants may actively relate to during the interaction. The participant or participants that acquire the foreign template for the first time may define the elements, parameters, and/or conditions within the template itself. One such example may be a template brought into a conversation by a supplier participant, which from his perspective is a sales agreement. The same template, viewed from a customer participant, would be a commitment to purchase. In this fashion, the two participants have altered views of the same template, where one participant views the template as an offer or agreement, and the other participant views the template as a commitment to that agreement. The conditions for both the agreement and commitment are consistent and coherent; all of which may occur within the same interaction. This differs from traditional methodology and systems for accounting.

As a result of interaction 1440 and the agreed upon terms by the participants, the communications OS 10 will then automatically update the finances and what might be thought of and constructed in traditional terminology, accounting ledgers of each of the participants to the interaction 1440 to reflect the newly agreed upon terms. Finances (and accounting ledgers) for participants who were not part of interaction 1440, but may be affected by interaction 1440 may also be automatically updated. For instance using a typical basic T account accounting notation as an illustration at 1450, Fred, who is the participant's and Jen's supervisor but was not part of interaction 1440, but is nonetheless accountable for this project is now aware of this interaction as a commitment for $10,000.00. This commitment now exists at this moment and represents a change for Dec. 22, 2012. Similarly at 1460, Jacob in accounting, who was also not a participant to interaction 1440 is made aware of interaction 1440 as what can be considered as a future liability increase of $10,000.00 as implied by the commitment to the agreement. These implications are derived by the agreement and commitments themselves, and do not need to be entered as in conventional accounting practices. At this point, Jacob is specifically aware of a future draw of cash committed for Jan. 12, 2013, in order to fulfill this commitment.

Traditionally, there are many processes such as sales agreements, purchase orders, invoices, payables, receivables, and other conventions that would require many activities such as accounts payable, accounts receivable, writing checks, collection phone calls, among other things. Within the interactivity accounting system provided by embodiments of the present invention, the aforementioned processes no longer exist. Rather, the terms of the agreement and associated commitments are designated in time, within the template itself. Expanding upon this example, this interaction might be one of a hundred or more such elements of an interaction; this particular interaction pertaining to a mast. The calendar maintains this interaction at 2:54 pm Dec. 22, 2012, the delivery on Dec. 28, 2012 and the draw on cash on Jan. 12, 2013. Virtual whiteboard 1445 can now be made available for a new set of considerations, commitments and agreements. In lieu of a linear structure and an involved list of agreements, commitments, terms and conditions, each simple negotiated step occurs in a schedule format that may be played in a linear fashion. Linearity only appears when replaying these interactions moment-by-moment. Otherwise what might normally be thought of as a complex process simply occurs in a structured environment. Part of this capacity allows for third party support or systems to integrate these interactions into a coherent project. No actions are required subsequent to the interactions.

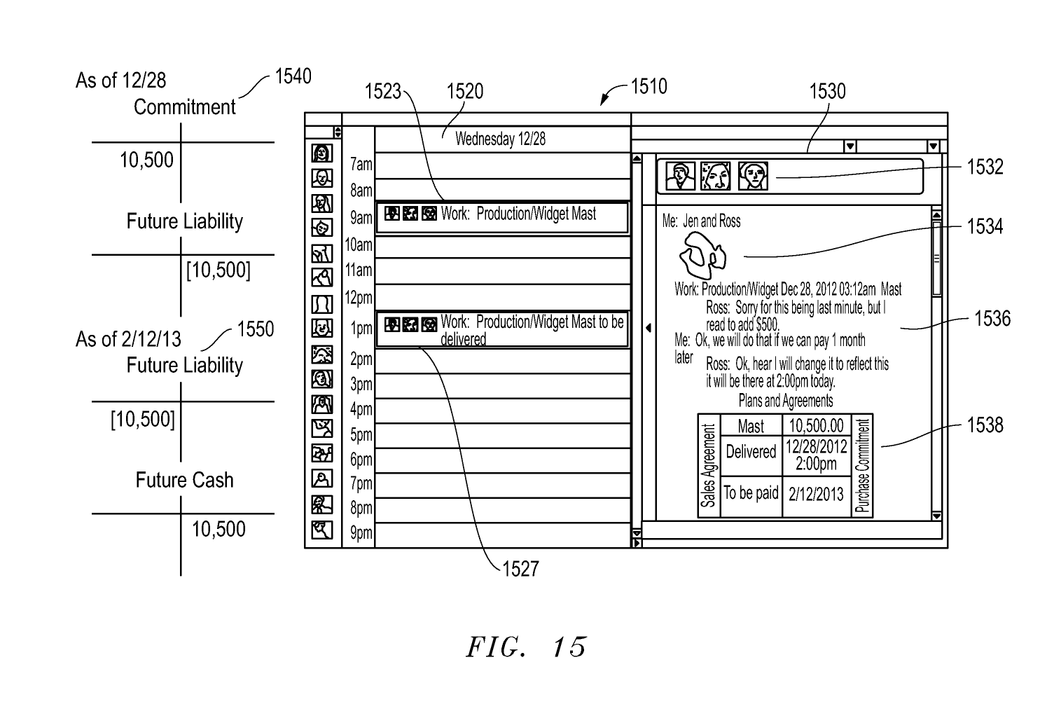

Next, at FIG. 15, a continuation of interaction 1440 is shown as a desktop 1510. As can be expected, changes to an interaction, agreement or commitment may sometimes occur after the initial agreement/commitment. Thus, the accounting aspect of communications OS 10 is likewise able to automatically adjust participants' finances and accounting ledgers in the event that an interaction, agreement or commitment is changed by one or more of the participants.

Similar to the daily calendar 1430, a daily calendar 1520 is provides for a calendar to assist the participant in keeping track of a current interaction 1440. A complete calendar view may be chosen that may provide and assist in tracking all of the interactions 1440, agreements and commitments historically related to the participant, as well as those that are scheduled for some time in the future. With regard to calendar 1520 as shown, the calendar shows interactions that occurred on Wednesday, Dec. 28, 2012 for a particular interaction on the participant's screen.

One recent occurrence 1523 is shown on calendar 1520. Recent occurrence 1523, is denoted with the interest and project “Work: Production/Widget Mast” which occurs at 9:12 a.m on Dec. 28, 2012. The participants to this interaction were the participant himself “me” and Ross, whereas Jen from recent occurrence 1435 and interaction 1440 was not an active part of recent occurrence 1523. When the participant touches or clicks on recent occurrence 1523, the specific interaction 1530 may appear or minimize on the right hand side of the screen. Additionally shown on calendar 1520 is a previously calendared occurrence 1527, which is to be the time when the “Production/Widget Mast” of previous interaction 1440 is delivered.

As illustrated in FIG. 15, interaction 1530 is essentially a continuation of interaction 1440 between the participant and other participants regarding the “Work: Production/Widget Mast” project. In interaction 1530, there is also a reminisce 1534 of the earlier interaction 1440 that occurred nearly a week earlier. Reminisce 1534 may be anything related to a previously occurring interaction that is tied to the current interaction, and may be anything that was previously represented on virtual whiteboard 1445. In this example, reminisce 1534 may be a brief remaining aspect of interaction 1440 from a week earlier. Specifically, reminisce 1534 is a drawing as part of the agreement for delivery in this instance that was shared by the participants of interaction 1440 that may be relevant to the now-current interaction 1530.

A participants list 1532 is shown within the interaction 1530, and illustrates one possible way that audio visual conversations might occur as an interaction. The participant “me” and Ross are active whereas Jen was included but was not an active participant during interaction 1530. Thus, Jen will become aware that the changes shown in interaction 1530, despite not being present for the interaction itself.

As a continuation to 1440, the participants interact within virtual whiteboard 1536 to discuss changes made to the project. Ross may go to the past interaction that took place on 12/22 at 2:54 p.m. and erase the negotiations, causing a new agreement/commitment to be implemented as the renegotiation occurs in the present. The past remains the same while the present (12/28 at 9:00 a.m.) and future (12/28 at 2:00 and Jan. 12, 2013 and Feb. 12, 2013) are influenced and updated as the current terms supersede the earlier terms. In interaction 1530, amendments are being discussed with respect to the sales agreement prior to delivery, and negotiations are engaged for the changes of the future sale/purchase price on virtual whiteboard 1536. Ross has had to add $500 to the cost of the mast project, to which the participant agrees if payment terms may be extended for a month. As Ross agrees to the new cost and payment conditions, these amended terms are automatically shown and updated in template 1538, which is used to show an updated purchase commitment in terms of price and date from template 1448 of the previously existing purchase commitment. At this point, Fred, who was not an active participant of this latest interaction 1530, is not aware of the change of this interaction yet. Once the purchase commitment is set in template 1538, Fred is made aware of the interaction 1530 at a typical basic T account accounting notation 1540 in the form of an adjusted commitment of $10,500.00 that now exists as of that particular moment in time (Dec. 28, 2012), and represents a change of $500.00 from Dec. 22, 2012, where the commitment was originally $10,000.00. At the same time, Jacob in accounting is aware of this interaction at 1550 as an implied future liability increased to $10,500.00. He is also aware of a future draw of cash for Feb. 12, 2013 a change from Jan. 12, 2013 to fulfill on this commitment.

Upon delivery on Dec. 28, 2012 at 2:00 p.m., the future cash may revert to an implied account payable if viewed from current traditions on Jacob's current transaction ledger. Specifically the influence on Jacob's accountabilies are transparent. In other words, using a typical basic T account accounting notation and typical accounting terminology, $10,500.00 may be credited from future cash and implied as an accounts payable as an applied debit in the current period payable on Feb. 12, 2013, whereas the commitment shown in 1450 of FIG. 14 may be credited and entered as an expense in the current period in ways to maintain GAAP for traditional accounting until the standards of accounting take the interactive accounting features of communications OS 10 into consideration. As a result, the rules of the current existing general accounting practices may be enhanced with greater details in a coherent and consistent manner. This can easily be accomplished implicitly where what is termed adjusting entries are not physically required.

The structure of agreements minus commitments equaling value simply provides a continuity for the current practices of dual entry accounting. In regards to the expansion of accounting dimensionally, it is the environment of interactions which remains coherent as a structure which gives accounting an interaction dimensionality. It is this structure that gives the many practices of management and strategic accounting a completely new footing as a real-time influence of interactions in its entirety can now give different methodologies a structure that requires no posterior or linear activities. The influence appears as time, scheduling and a temporal relation for accountabilities. Ultimately, accounting expands in language, financial, resource (including persons and other entities) and/or material within a temporal structure. Transparency for given accountabilities are inherent. The capacity for structure give way for transparency as a design. For instance new employees might have the attention of those accountable to a much greater degree than those experienced. What gets accounted for isn't limited to finances and resources. Language and terminology can be accounted for also for legalities, supervision, project management. Terms like legal, delay and so on might provide a window of transparency for those responsible. All of this occurs as a function of relationships and resources 30. The structure of accounting is a function of relationships 30. Over time these relationships alter and the degree of transparency alters when mentoring and direct oversight is no longer warranted in other words the participant is assessed in a scale of competency. While the transition from current practices, this transition in no way limits the novelty of interactivity accounting or the accounting and accountability of interactions and interactivities.

It will be readily apparent to those skilled in the art that the general principles defined herein may be applied to other embodiments and applications without departing from the spirit and scope of the present invention. Having thus described the exemplary embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is contemplated that the appended claims will cover any such modifications or embodiments that fall within the true scope of the invention.

What is claimed is:

1. A method for providing feedback in an interest centric, interactive communications environment, the method comprising the steps of:
providing one or more electronic devices configured to communicate over a communications network;
providing one or more servers configured to provide interactive data to the electronic devices over the communications network and to control the interactive data and to coordinate participant activities via the electronic devices over the communications network;
authenticating one or more participants by the electronic devices;
monitoring a condition of at least one of the participants via a capture device on the electronic device;
generating a condition signal responsive to the monitored condition and transmitting the condition signal to one of the servers;
analyzing by the server the condition signal to determine an emotional state of the participant;
providing feedback to the participant based upon the determined emotional state; and
modifying the interactive data based upon the determined emotional state, wherein the interactive data comprises at least one of interest items, relationship and resource items and stuff.

2. The method of claim 1, wherein the monitored condition comprises a facial expression of the participant.

3. The method of claim 1, wherein the monitored condition includes at least one of the following: vocal inflections, skin color, body temperature, retinal condition, infra-red signatures, electromagnetic signals and electrostatic signals.

4. The method of claim 1, wherein the monitored condition includes word selection utilized by the participant during interaction with the communications environment.

5. The method of claim 1, wherein the capture device is camera.

6. The method of claim 1, wherein the capture device is selected from the group consisting of: microphone, infrared sensors, optical sensors, electromagnetic sensors, temperature sensors and electrostatic sensors.

7. The method of claim 1, wherein the feedback comprises visible feedback.

8. The method of claim 1, wherein the feedback comprises audio feedback.

9. The method of claim 1, wherein the feedback comprises haptic feedback.

10. The method of claim 7, wherein the visible feedback comprises adjusting the appearance of a desktop of the electronic device.

11. The method of claim 10, wherein the appearance of the desktop is adjusted by displaying different colored hues correlating to different emotional states of the participant.

12. The method of claim 7, wherein the visible feedback comprises different brightness levels correlating to different emotional states of the participant.

13. A data processing system for providing feedback in an interest centric, interactive communications environment, the data processing system, comprising:
at least one processor;
a memory connected to the processor, wherein the data processing system is configured to:
authenticate one or more participants of electronic devices;
monitor a condition of at least one of the participants via a capture device on the electronic device;
generate a condition signal responsive to the monitored condition by the capture device;
analyze the condition signal to determine an emotional state of the participant;
provide feedback to the participant based upon the determined emotional state; and
modify the interactive data based upon the determined emotional state, wherein the interactive data comprises at least one of interest items, relationship and resource items and stuff.

14. The data processing system of claim 13, wherein the monitored condition comprises a facial expression of the participant.

15. The data processing system of claim 13, wherein the monitored condition includes at least one of the following: vocal inflections, skin color, body temperature, retinal condition, infra-red signatures, electromagnetic signals and electrostatic signals.

16. The data processing system of claim 13, wherein the monitored condition includes word selection utilized by the participant during interaction with the communications environment.

17. The data processing system of claim 13, wherein the feedback comprises visible feedback.

18. The data processing system of claim 11, wherein the feedback comprises audio feedback.

19. The data processing system of claim 13, wherein the feedback comprises haptic feedback.

20. The data processing system of claim 17, wherein the visible feedback comprises adjusting the appearance of a desktop of the electronic device.

21. The data processing system of claim 20, wherein the appearance of the desktop is adjusted by displaying different colored hues correlating to different emotional states of the participant.

22. The data processing system Of claim 17, wherein the visible feedback comprises different brightness

23. A system for providing feedback in an interest centric, interactive communications environment, the system comprising:
one or more electronic devices configured to communicate over a communications network;
one or more servers configured to provide interactive data to the electronic devices over the communications network and to control the interactive data and to coordinate participant activities via the electronic devices over the communications network;
one or more authenticating devices on the electronic devices configured to authenticate participants of the electronic devices;
one or more monitoring devices on the electronic devices configured to monitor a condition of the participants and operable to generate a condition signal responsive to the monitored condition and to transmit the condition signal to one of the servers,
wherein the condition signal is analyzed to determine an emotional state of the participant and to provide feedback to the participant based upon the determined emotional state, and
wherein the interactive data is modified based upon the determined emotional state, and wherein the interactive data comprises at least one of interest items, relationship and resource items and stuff.

24. The system of claim 23, wherein the electronic devices comprise:
one or more processors;
one or more storage devices connected to the processor; and
one or more displays connected to the processor.

25. The system of claim 23, wherein the communications network comprises the Internet.

26. The system of claim 23, wherein the communications network comprises a wireless network.

27. The system of claim 23, wherein the communications network comprises one or more of the following: a telephone network, satellite network, microwave network, and cable network.

28. The system of claim 23, wherein the monitored condition comprises a facial expression of the participant.

29. The system of claim 23, wherein the monitored condition includes at least one of the following: vocal inflections, skin color, body temperature, retinal condition, infra-red signatures, electromagnetic signals and electrostatic signals.

30. The system of claim 23, wherein the monitored condition includes word selection utilized by the participant during interaction with the communications environment.

31. The system of claim 23, wherein the capture device is camera.

32. The system of claim 23, wherein the capture device is selected from the group consisting of: microphone, infrared sensors, optical sensors, electromagnetic sensors, temperature sensors and electrostatic sensors.

33. The system of claim 23, wherein the feedback comprises visible feedback.

34. The system of claim 23, wherein the feedback comprises audio feedback.

35. The system of claim 23, wherein the feedback comprises haptic feedback.

36. The system of claim 33, wherein the visible feedback comprises adjusting the appearance of a desktop of the electronic device.

37. The system of claim 36, wherein the appearance of the desktop is adjusted by displaying different colored hues correlating to different emotional states of the participant.

38. The system of claim 33, wherein the visible feedback comprises different brightness levels correlating to different emotional states of the participant.

39. The system of claim 23, wherein the communications network comprises one or more of the following: telephone network, satellite network, microwave network, and cable network.
